(19) United States
(12) Patent Application Publication
(10) Pub. No.: US 2023/0271710 A1
(43) Pub. Date: Aug. 31, 2023

(54) INTEGRATED ELECTRIC PROPULSION ASSEMBLY

(71) Applicant: BETA AIR, LLC, SOUTH BURLINGTON, VT (US)

(72) Inventors: Raffaelo Verna, Creedmoor, NC (US); Riley Griffin, SOUTH BURLINGTON, VT (US); Nathan Wiegman, Essex Junction, VT (US); Manon Danielle Belzile, Fairfield, VT (US)

(73) Assignee: BETA AIR, LLC, SOUTH BURLINGTON, VT (US)

(21) Appl. No.: 18/143,923

(22) Filed: May 5, 2023

Related U.S. Application Data
(63) Continuation-in-part of application No. 16/910,255, filed on Jun. 24, 2020, now Pat. No. 11,679,891.
Application No. 16/910,255 is a continuation-in-part of application No. 16/703,225, filed on Dec. 4, 2019, now Pat. No. 11,383,850.
(60) Provisional application No. 62/858,281, filed on Jun. 6, 2019.

(51) Int. Cl. B64D 27/24; H02K 11/25; H02K 11/33; H02K 16/02

(52) U.S. Cl. CPC B64D 27/24; H02K 11/25; H02K 11/33; H02K 16/02; B64C 29/0008

(57) ABSTRACT

An electrical propulsor motor may include a stator having a hollow cylinder with an inner cylindrical surface and an outer cylindrical surface, rotor incorporated in a hub of a propulsor and mounted to the stator, including a first cylindrical surface facing the inner cylindrical surface, where the inner cylindrical surface and first cylindrical surface form a first air gap, a second cylindrical surface facing the outer cylindrical surface, wherein the outer cylindrical surface and the second cylindrical surface form a second air gap, and a plurality of axial impeller vanes mounted to at least one of the first cylindrical surface and the second cylindrical surface and within at least one of the first air gap and the second air gap and positioned to force air through the at least one of the first air gap and the second air gap when the rotor rotates about the axis of rotation.

### CROSS-REFERENCE TO RELATED APPLICATIONS

This application is a continuation in part of U.S. Nonprovisional application Ser. No. 16/910,255, filed on Jun. 24, 2020, and entitled “AN INTEGRATED ELECTRIC PROPULSION ASSEMBLY,” which is a continuation in part of U.S. Nonprovisional application Ser. No. 16/703,225, filed on Dec. 4, 2019, and entitled “AN INTEGRATED ELECTRIC PROPULSION ASSEMBLY,” which claims the benefit of priority of U.S. Provisional Patent Application Ser. No. 62/858,281, filed on Jun. 6, 2019, and entitled “INTEGRATED ELECTRIC PROPULSION ASSEMBLY,” each of which is incorporated by reference herein in its entirety.

### FIELD OF THE INVENTION

The present invention generally relates to the field of electric aircraft propulsion assemblies. In particular, the present invention is directed to an integrated electric propulsion assembly.

### BACKGROUND

In electric multi-propulsion systems such as electric vertical take-off and landing (eVTOL) aircraft, the propulsors are constrained by volumetric, gravimetric and thermal concerns. Design and assembly of the propulsor units must be done in a manner which reduces volumetric, gravimetric and thermal issues to enable efficient flight. Existing approaches to mitigating this problem are limited.

### SUMMARY OF THE DISCLOSURE

In an aspect, an electrical propulsor motor is described. The motor includes an axis of rotation and a stator affixed to a vertical take-off and landing aircraft, wherein the stator comprises a through-hole located at the axis of rotation. The motor further includes a rotor mechanically coupled to a shaft and mounted in magnetic communication with the stator, wherein the rotor is rotatably mounted about the axis of rotation and the rotor includes a first cylindrical surface facing the stator, wherein the stator and the first cylindrical surface form a first air gap. The motor further includes a shaft operatively coupled to the rotor and rotatably mounted to the vertical take-off and landing aircraft, the shaft located coaxially with the axis of rotation. The motor further includes an impeller operatively coupled to the shaft and configured to force air through an air flow path adjacent at least a winding of the stator. The motor further includes a propulsor affixed to the shaft and configured to generate a lift thrust on the electric vertical take-off and landing aircraft as a function of rotation of the shaft.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is an exploded view of an embodiment of an integrated electric propulsion assembly;

FIG. 2 is an illustration of an embodiment of a stator including an inverter;

FIG. 3 is a partial cross-sectional view of an embodiment of an integrated electric propulsion assembly including a cooling apparatus;

FIG. 4 is an exploded view of an embodiment of an integrated propulsion assembly;

FIG. 5 is a block diagram of an embodiment of an integrated electric propulsion assembly;

FIG. 6 is an embodiment of an integrated electric propulsion assembly incorporated in an electric aircraft;

FIG. 7 is a cross-sectional view of an exemplary embodiment of a motor showing air gaps on both sides of a stator;

FIG. 8 is partial sectional view of an exemplary embodiment of a motor showing air gaps on both sides of a stator;

FIG. 9 is a cross-sectional view of an exemplary embodiment of an outer rotor cooling liner;

FIG. 10 is a cross-sectional view of an exemplary embodiment of an inner rotor cooling liner; and

FIG. 11 is a block diagram of an exemplary embodiment of a propulsion system of an electric aircraft in accordance with one or more embodiments of the present disclosure;

FIG. 12 is an illustration of a perspective view of an exemplary embodiment of an electric aircraft in accordance with one or more embodiments of the present disclosure;

FIG. 13 is a block diagram of an exemplary embodiment of a flight controller in accordance with one or more embodiments of the present disclosure;

FIG. 14 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

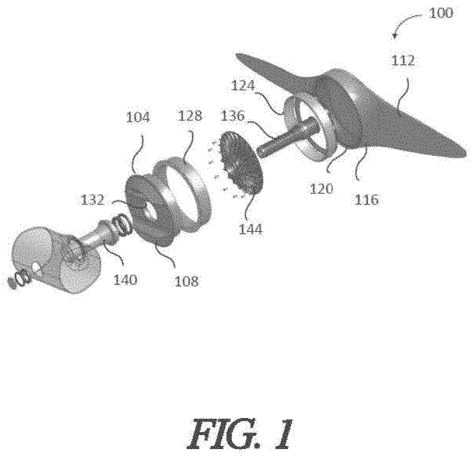

In the following description, for the purposes of explanation, numerous specific details are set forth in order to provide a thorough understanding of the present invention. It will be apparent, however, that the present invention may be practiced without these specific details. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply embodiments of the inventive concepts defined in the appended claims. Hence, specific dimensions and other physical characteristics relating to the embodiments disclosed herein are not to be considered as limiting, unless the claims expressly state otherwise.

Embodiments of the system disclosed herein utilize integrated electric propulsion assemblies combining a rotor of an electric motor directly into a propulsor. Such assemblies may provide thrust in electric aircraft for situations such as takeoff, landing, hovering, or high-turbulence situations. The design of an integrated electric propulsion assembly offers benefits such as weight reduction. Additional benefits may include reduced drag from wind resistance, by avoiding a higher profile assembly, such as conventional assemblies mounting propulsors to motors by way of a collar or flange. Integrated electric propulsion assemblies may be enclosed in chambers in structural elements such as wings or outriggers of electric aircraft or other vehicles; in some embodiments, an integrated electric propulsion assembly may be used to reduce drag on the structural elements which reduces the demand on the energy source enabling longer flight times, especially in critical missions or in missions where the flight plans may be changed due to unforeseen environmental circumstances encountered during flight. In some embodiments, integrated electric propulsion assemblies may have elements which also function to cool internal components during flight. In another embodiment, an integrated electric propulsion assembly is integrated into one unit allowing for ease of installation, removal, maintenance, or troubleshooting.

Referring now to FIG. 1, an embodiment of an integrated electric propulsion assembly 100 is illustrated. Integrated electric propulsion assembly 100 includes at least a stator 104. Stator 104, as used herein, is a stationary component of a motor and/or motor assembly. In an embodiment, stator 104 includes at least a first magnetic element 108. As used herein, first magnetic element 108 is an element that generates a magnetic field. For example, first magnetic element 108 may include one or more magnets which may be assembled in rows along a structural casing component. Further, first magnetic element 108 may include one or more magnets having magnetic poles oriented in at least a first direction. The magnets may include at least a permanent magnet. Permanent magnets may be composed of, but are not limited to, ceramic, alnico, samarium cobalt, neodymium iron boron materials, any rare earth magnets, and the like. Further, the magnets may include an electromagnet. As used herein, an electromagnet is an electrical component that generates magnetic field via induction; the electromagnet may include a coil of electrically conducting material, through which an electric current flow to generate the magnetic field, also called a field coil of field winding. A coil may be wound around a magnetic core, which may include without limitation an iron core or other magnetic material. The core may include a plurality of steel rings insulated from one another and then laminated together; the steel rings may include slots in which the conducting wire will wrap around to form a coil. A first magnetic element 108 may act to produce or generate a magnetic field to cause other magnetic elements to rotate, as described in further detail below. Stator 104 may include a frame to house components including at least a first magnetic element 108, as well as one or more other elements or components as described in further detail below. In an embodiment, a magnetic field can be generated by a first magnetic element 108 and can comprise a variable magnetic field. In embodiments, a variable magnetic field may be achieved by use of an inverter, a controller, or the like. In an embodiment, stator 104 may have an inner and outer cylindrical surface; a plurality of magnetic poles may extend outward from the outer cylindrical surface of the stator. In an embodiment, stator 104 may include an annular stator, wherein the stator is ring-shaped. In an embodiment, stator 104 is incorporated into a DC motor where stator 104 is fixed and functions to supply the magnetic fields where a corresponding rotor, as described in further detail below, rotates.

Still referring to FIG. 1, integrated electric propulsion assembly 100 includes propulsor 112. In embodiments, propulsor 112 can include an integrated rotor. As used herein, a rotor is a portion of an electric motor that rotates with respect to a stator of the electric motor, such as stator 104. A propulsor, as used herein, is a component or device used to propel a craft by exerting force on a fluid medium, which may include a gaseous medium such as air or a liquid medium such as water. Propulsor 112 may be any device or component that consumes electrical power on demand to propel an aircraft or other vehicle while on ground and/or in flight. Propulsor 112 may include one or more propulsive devices. In an embodiment, propulsor 112 can include a thrust element which may be integrated into the propulsor. A thrust element may include any device or component that converts the mechanical energy of a motor, for instance in the form of rotational motion of a shaft, into thrust in a fluid medium. For example, a thrust element may include without limitation a marine propeller or screw, an impeller, a turbine, a pump-jet, a paddle or paddle-based device, or the like. As another non-limiting example, at least a propulsor may include an eight-bladed pusher propeller, such as an eight-bladed propeller mounted behind the engine to ensure the drive shaft is in compression. Persons skilled in the art, upon reviewing the entirety of this disclosure, will be aware of various devices that may be used as at least a thrust element. As used herein, a propulsive device may include, without limitation, a device using moving or rotating foils, including without limitation one or more rotors, an airscrew or propeller, a set of airscrews or propellers such as contra-rotating propellers, a moving or flapping wing, or the like. In an embodiment, propulsor 112 may include at least a blade. As another non-limiting example, a propulsor may include an eight-bladed pusher propeller, such as an eight-bladed propeller mounted behind the engine to ensure the drive shaft is in compression. Persons skilled in the art, upon reviewing the entirety of this disclosure, will be aware of various devices that may be used as propulsor 112. In an embodiment, when a propulsor twists and pulls air behind it, it will, at the same time, push the aircraft forward with an equal amount of force. The more air pulled behind the aircraft, the more the aircraft is pushed forward. In an embodiment, thrust element may include a helicopter rotor incorporated into propulsor 112. A helicopter rotor, as used herein, may include one or more blade or wing elements driven in a rotary motion to drive fluid medium in a direction axial to the rotation of the blade or wing element. Its rotation is due to the interaction between the windings and magnetic fields which produces a torque around the rotor's axis. A helicopter rotor may include a plurality of blade or wing elements.

Continuing to refer to FIG. 1, propulsor 112 can include a hub 116 rotatably mounted to stator 104. Rotatably mounted, as described herein, is functionally secured in a manner to allow rotation. Hub 116 is a structure which allows for the mechanically coupling of components of the integrated rotor assembly. In an embodiment, hub 116 can be mechanically coupled to propellers or blades. In an embodiment, hub 116 may be cylindrical in shape such that it may be mechanically joined to other components of the rotor assembly. Hub 116 may be constructed of any suitable material or combination of materials, including without limitation metal such as aluminum, titanium, steel, or the like, polymer materials or composites, fiberglass, carbon fiber, wood, or any other suitable material. Hub 116 may move in a rotational manner driven by interaction between stator and components in the rotor assembly. Persons skilled in the art, upon reviewing the entirety of this disclosure, will be aware of various structures that may be used as or included as hub 116, as used and described herein.

Still referring to FIG. 1, propulsor 112 can include a second magnetic element 120, which may include one or more further magnetic elements. Second magnetic element 120 generates a magnetic field designed to interact with first magnetic element 108. Second magnetic element 120 may be designed with a material such that the magnetic poles of at least a second magnetic element are oriented in an opposite direction from first magnetic element 108. In an embodiment, second magnetic element 120 may be affixed to hub 116. Affixed, as described herein, is the attachment, fastening, connection, and the like, of one component to another component. For example and without limitation, affixed may include bonding the second magnetic element 120 to hub 116, such as through hardware assembly, spot welding, riveting, brazing, soldering, glue, and the like. Second magnetic element 120 may include any magnetic element suitable for use as a first magnetic element 108. For instance, and without limitation, second magnetic element may include a permanent magnet and/or an electromagnet. Second magnetic element 120 may include magnetic poles oriented in a second direction opposite of the orientation of the poles of first magnetic element 108. In an embodiment, electric propulsion assembly 100 includes a motor assembly incorporating stator 104 with a first magnet element and second magnetic element 120. First magnetic element 108 includes magnetic poles oriented in a first direction, a second magnetic element includes a plurality of magnetic poles oriented in the opposite direction than the plurality of magnetic poles in the first magnetic element 108.

Continuing to refer to FIG. 1, second magnetic element 120 may include a plurality of magnets attached to or integrated in hub 116. In an embodiment, hub 116 may incorporate structural elements of the rotor assembly of the motor assembly. As a non-limiting example hub 116 may include a motor inner magnet carrier 124 and motor outer magnet carrier 128 incorporated into the hub 116 structure. In an embodiment motor inner magnet carrier 124 and motor outer magnet carrier 128 may be cylindrical in shape. In an embodiment, motor inner magnet carrier 124 and motor out magnet carrier 116 may be any shape that would allow for a fit with the other components of the rotor assembly. In an embodiment, hub 116 may be short and wide in shape to reduce the profile height of the rotating assembly of electric propulsion assembly 100. Reducing the profile assembly height may have the advantage of reducing drag force on the external components. In an embodiment, hub 116 may also be cylindrical in shape so that fitment of the components in the rotor assembly are structurally rigid while leaving hub 116 free to rotate about stator. In an embodiment, motor outer magnet carrier 128 may have a slightly larger diameter than motor inner magnet carrier 124, or vice-versa. First magnetic element 108 may be a productive element, defined herein as an element that produces a varying magnetic field. Productive elements will produce magnetic field that will attract and other magnetic elements, including a receptive element. Second magnetic element may be a productive or receptive element. A receptive element will react due to the magnetic field of a first magnetic element 108. In an embodiment, first magnetic element 108 produces a magnetic field according to magnetic poles of first magnetic element 108 oriented in a first direction. Second magnetic element 120 may produce a magnetic field with magnetic poles in the opposite direction of the first magnetic field, which may cause the two magnetic elements to attract one another. Receptive magnetic element may be slightly larger in diameter than the productive element. Interaction of productive and receptive magnetic elements may produce torque and cause the assembly to rotate. Hub 116 and rotor assembly may both be cylindrical in shape where rotor may have a slightly smaller circumference than hub 116 to allow the joining of both structures. Coupling of hub 116 to stator 104 may be accomplished via a surface modification of either hub 116, stator 104 or both to form a locking mechanism. Coupling may be accomplished using additional nuts, bolts, and/or other fastening apparatuses. In an embodiment, an integrated rotor assembly as described above reduces profile drag in forward flight for an electric aircraft. Profile drag may be caused by a number of external forces that the aircraft is subjected to. By incorporating a propulsor 112 into hub 116, a profile of integrated electric propulsion assembly 100 may be reduced, resulting in a reduced profile drag, as noted above. In an embodiment, the rotor, which includes motor inner magnet carrier 124, motor outer magnet carrier 128, propulsor 112 is incorporated into hub 116 to become one integrated unit. In an embodiment, inner motor magnet carrier 112 rotates in response to a magnetic field. The rotation causes hub 116 to rotate. This unit can be inserted into integrated electric propulsion assembly 100 as one unit. This enables ease of installation, maintenance and removal.

Still referring to FIG. 1, stator 104 may include a through-hole 132. Through-hole 132 may provide an opening for a component to be inserted through to aid in attaching propulsor with integrated rotor to stator. In an embodiment, through-hole 132 may have a round or cylindrical shape and be located at a rotational axis of stator 104. Hub 116 may be mounted to stator 104 by means of a shaft 136 rotatably inserted though through hole 132. Through-hole 132 may have a diameter that is slightly larger than a diameter of shaft 136 to allow shaft 136 to fit through through-hole 132 in order to connect stator 104 to hub 116. Shaft 136 may rotate in response to rotation of propulsor 112.

Still referring to FIG. 1, integrated electric propulsion assembly 100 may include a bearing cartridge 140. Bearing cartridge 140 may include a bore. Shaft 136 may be inserted through the bore of bearing cartridge 140. Bearing cartridge 140 may be attached to a structural element of a vehicle. Bearing cartridge 140 functions to support the rotor and to transfer the loads from the motor. Loads may include, without limitation, weight, power, magnetic pull, pitch errors, out of balance situations, and the like. A bearing cartridge 140 may include a bore. a bearing cartridge 140 may include a smooth metal ball or roller that rolls against a smooth inner and outer metal surface. The rollers or balls take the load, allowing the device to spin. a bearing may include, without limitation, a ball bearing, a straight roller bearing, a tapered roller bearing or the like. a bearing cartridge 140 may be subject to a load which may include, without limitation, a radial or a thrust load. Depending on the location of bearing cartridge 140 in the assembly, it may see all of a radial or thrust load or a combination of both. In an embodiment, bearing cartridge 140 may join integrated electric propulsion assembly 100 to a structure feature. a bearing cartridge 140 may function to minimize the structural impact from the transfer of bearing loads during flight and/or to increase energy efficiency and power of propulsor. a bearing cartridge 140 may include a shaft and collar arrangement, wherein a shaft affixed into a collar assembly. A bearing element may support the two joined structures by reducing transmission of vibration from such bearings. Roller (rolling-contact) bearings are conventionally used for locating and supporting machine parts such as rotors or rotating shafts. Typically, the rolling elements of a roller bearing are balls or rollers. In general, a roller bearing is a is type of anti-friction bearing; a roller bearing functions to reduce friction allowing free rotation. Also, a roller bearing may act to transfer loads between rotating and stationary members. In an embodiment, bearing cartridge 140 may act to keep a propulsor 112 and components intact during flight by allowing integrated electric propulsion assembly 100 to rotate freely while resisting loads such as an axial force. In an embodiment, bearing cartridge 140 includes a roller bearing incorporated into the bore. a roller bearing is in contact with propulsor shaft 136. Stator 104 is mechanically coupled to inverter housing 140. Mechanically coupled may include a mechanical fastening, without limitation, such as nuts, bolts or other fastening device. Mechanically coupled may include welding or casting or the like. Inverter housing contains a bore which allows insertion by propulsor shaft 136 into bearing cartridge 140.

Still referring to FIG. 1, electric propulsion assembly 100 may include a motor assembly incorporating a rotating assembly and a stationary assembly. Hub 116, motor inner magnet carrier 124 and propulsor shaft 136 may be incorporated into the rotor assembly of electric propulsion assembly 100 which make up rotating parts of electric motor, moving between the stator poles and transmitting the motor power. As one integrated part, the rotor assembly may be inserted and removed in one piece. Stator 104 may be incorporated into the stationary part of the motor assembly. Stator and rotor may combine to form an electric motor. In embodiment, an electric motor may, for instance, incorporate coils of wire which are driven by the magnetic force exerted by a first magnetic field on an electric current. The function of the motor may be to convert electrical energy into mechanical energy. In operation, a wire carrying current may create at least a first magnetic field with magnetic poles in a first orientation which interacts with a second magnetic field with magnetic poles oriented in the opposite direction of the first magnetic pole direction causing a force that may move a rotor in a direction. For example and without limitation, a first magnetic element 108 in electric propulsion assembly 100 may include an active magnet. For instance and without limitation, a second magnetic element may include a passive magnet, a magnet that reacts to a magnetic force generated by a first magnetic element 108. In an embodiment, a first magnet and a second magnet, positioned around the rotor assembly, may generate magnetic fields to affect the position of the rotor relative to the stator. A controller 604 may have an ability to adjust electricity originating from a power supply and, thereby, the magnetic forces generated, to ensure stable rotation of the rotor, independent of the forces induced by the machinery process. Electric propulsion assembly 100 may include an impeller 144 coupled with the shaft 136. An impeller, as described herein, is a rotor used to increase or decrease the pressure and flow of a fluid and/or air. Impeller 144 may function to provide cooling to electric propulsion assembly 100. Impeller 144 may include varying blade configurations, such as radial blades, non-radial blades, semi-circular blades and airfoil blades. Impeller 114 may further include single and/or double-sided configurations. Impeller 114 is described in further detail below.

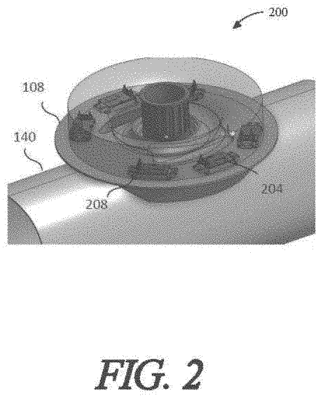

Now referring to FIG. 2, an embodiment of an inverter housing 200 is shown. Inverter housing 200 may provide structural support to stator 104 and other components of the assembly. Inverter housing 200 may include air ducts 204. Air ducts 204 are designed to allow air flow into electric propulsion assembly 100 during use. Inverter housing may include inverters 208. Inverter 208 may function as a frequency converter and changes the DC power from a power source into AC power to drive the motor by adjusting the frequency and voltage supplied to the motor. Inverter 208 may be entirely electronic or a combination of mechanical elements and electronic circuitry. Inverter 208 may allow for variable speed and torque of the motor based on the demands of the vehicle. Inverter housing may be made of any suitable materials to enclose and protect the components of the inverter. Inverter housing 200 made me made out of varying materials such as, any metal, stainless steel, plastic or combination of multiple materials. Inverter housing 200 may be in any shape that enclosed the inverter components and fits into the assembly.

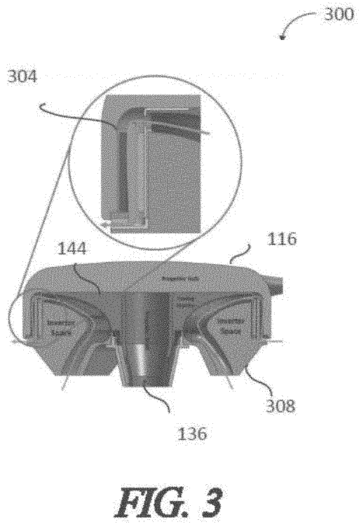

Referring now to FIG. 3, assembly 100 may include a cooling apparatus 300. Cooling apparatus 300 may function to cool components of the integrated electric propulsion assembly 100 during operation. Cooling may help to protect internal and external components of assembly 100 from fatigue resulting from loads places during operation. During operation, components may become heated due to use, friction, current flow. Cooling apparatus 300 may be a device which has a volume of liquid which provides cooling. Cooling apparatus 300 may be a device which uses airflow to provide cooling. Cooling apparatus 300 may include channels and ducts to allow air from the environment into the integrated electric propulsion assembly 100. Cooling apparatus 300 may include an impeller 144; impeller 144 may function to direct air flow to cool integrated electric propulsion assembly 100 components. Impeller may be integrated into stator 104 and hub 116 and may include a gap 304. Gap 304 may exist between the inverter housing, impeller and stator 104 allow cooling air to flow through electric propulsion assembly 100 during use. Gap 304 may be a duct, channel, gap such as the motor rotor-stator gaps, or the like.

Still referring to FIG. 3, electric propulsion assembly 100 may include an interior space in hub 116. In an embodiment, impeller 144 may be inserted into the interior space. Interior space may include an inverter space 308. In an embodiment, impeller 144 internally installed in assembly may drive air through finned passageways in the inverter housing and through the motor rotor-stator gaps. This may remove liquid cooling requirements from a cooling element which in turn may reduce the thermal infrastructure and reduce system weight. Impeller 144 may act as a nearly passive cooling element, drawing minimal power from the motor by making use of the existing rotation of the propeller. Impeller 144 may also act as a structural element to provide rigidity in the propeller-prop shaft interface. This design may optionally include a fairing at the base of the inverter housing, to direct ambient air to the inlets in the inverter housing, as well as increasing aerodynamic performance in forward flight by blending the inverter housing to the surrounding structure. a portion of cooling apparatus 300, such as without limitation impeller, may be mechanically coupled to hub 116. Cooling apparatus 300 may include a bore which fits propulsor shaft 136 and into the interior space of hub 116. Cooling apparatus 300 and/or impeller may function to generate an air flow within the interior space when hub 116 rotates.

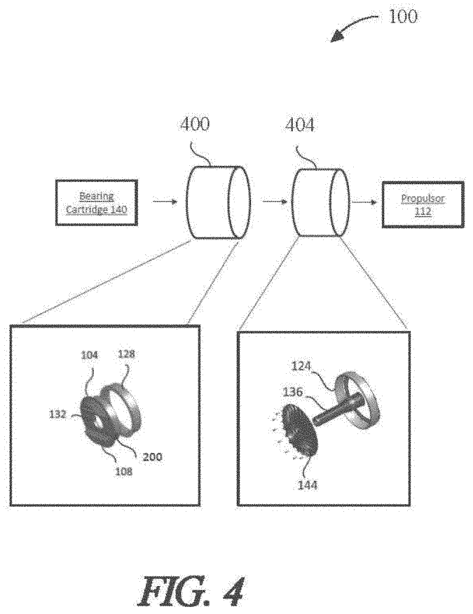

Now referring to FIG. 4, electric propulsion assembly 100 may include a first annular cylindrical section 400 that houses a first magnetic element 108. Electric propulsion assembly 100 may further include a second magnetic element 120 may be housed in a second annual cylindrical section 404. Second annular cylindrical section 404 may fit concentrically into the first annular cylindrical section. First annular cylindrical section 400 may be constructed of any materials with appropriate properties such as, without limitation, strength and resistance to torque and other forces experienced during use, including while in air. In an embodiment, first annular cylindrical section 400 and second annular cylindrical section 404 may be integrated into hub 116. In an embodiment, first annular cylindrical section 400 may include shaft 136 which may connect impeller 144, and outer motor magnet 124 and be joined with hub 116 and propulsor 112 or another structural element. Second annular cylindrical section 404 may include stator 104, inner motor magnet carrier 128 and/or inverter housing 200 and may be joined to bearing cartridge 140 or another structural element. In this embodiment, the components contained within first annular cylindrical section 400 and second annular cylindrical section 404, when joined, will function to provide thrust for electric propulsion assembly 100. First annular cylindrical section 400 may be inserted into the second annular cylindrical section 404 concentrically as the outer diameter of first annular cylindrical section 400 is smaller than the inner diameter of the second annular cylindrical section 404.

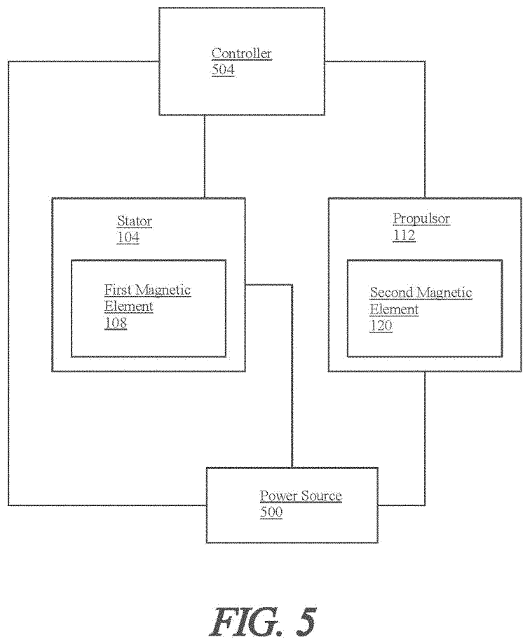

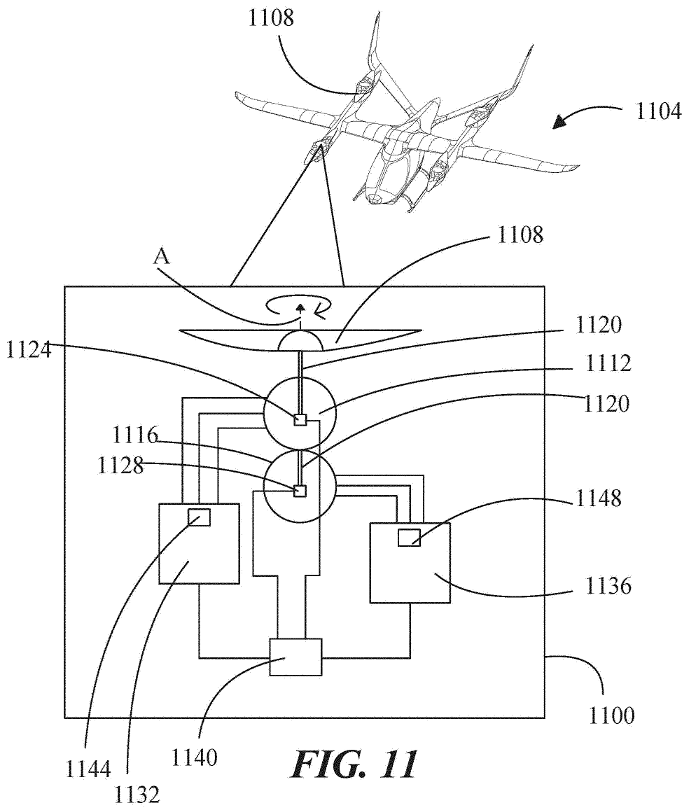

Referring now to FIG. 5, a block diagram of an embodiment of an integrated electric propulsion assembly 100 is illustrated. Assembly 100 may include a power source 500 to provide electrical energy to the stator 104 for the generation of a magnetic field by the plurality of magnets. a power source 500 may be driven by direct current (DC) electric power; for instance, a power source 500 may include, without limitation, brushless DC electric motors, switched reluctance motors, or induction motors. For instance and without limitation, a power source 500 may include electronic speed controllers (not shown) or other components for regulating motor speed, rotation direction, and/or dynamic braking. Power source 500 may include or be connected to one or more sensors (not shown) detecting one or more conditions of at power source 500. The conditions may include, without limitation, voltage levels, electromotive force, current levels, temperature, current speed of rotation, and the like. The sensors may communicate a current status of power source 500 to a person operating electric propulsion assembly 100 or a computing device; computing device may include any computing device as described below in reference to FIG. 11, including without limitation a vehicle controller as set forth in further detail below. Persons skilled in the art, upon reviewing the entirety of this disclosure, will be aware of various devices and/or components that may be used as or included a power source 500 or a circuit operating a power source 500, as used and described herein. As a further example and without limitation, a power source 500 may include a battery cell. Power source 500 may be a high specific energy density energy source designed to deliver an amount of energy per mass for a period of time. Specific energy capacity is expressed in units of Wh/kg. Power sources 500 may be designed as high energy density to supply a load for extended periods of time, repeatedly. High specific power density energy sources are designed to deliver a high amount of power in a specific period of time. Specific power density is expressed in units of W/kg. Power source 500 may be designed as high-power density to be capable of delivering high amounts of power in shorter amounts of time repeatedly. In an embodiment, power source 500 include both a high specific energy source and a high specific power source with technology such as a lithium ion battery, the high specific power density energy source may have a higher voltage made available by connected the cells in series to increase the voltage than high specific energy density energy source. Some battery chemistries offer better energy density than power density and vice versa. Most lithium ion chemistries offer both qualities and are arrange and/or used to supply either energy or power or both for a given application. The application and demand on the battery for a particular period of time will determine is that particular assembly is a high energy density energy source or a high-power density energy source. For example power source 500 may include, without limitation, a generator, a capacitor, a supercapacitor, a photovoltaic device, a fuel cell such as a hydrogen fuel cell, direct methanol fuel cell, and/or solid oxide fuel cell, or an electric energy storage device; electric energy storage device may include without limitation a capacitor, an inductor, and/or a battery.

Still referring to FIG. 5, integrated electric propulsion assembly 100 may include controller 504. Controller 504 may include and/or communicate with any computing device as described in this disclosure, including without limitation a microcontroller, microprocessor, digital signal processor (DSP) and/or system on a chip (SoC) as described in this disclosure. Controller 504 may be installed in an aircraft, may control the aircraft remotely, and/or may include an element installed in the aircraft and a remote element in communication therewith. Controller 504 may include, be included in, and/or communicate with a mobile device such as a mobile telephone or smartphone. Controller 504 may include a single computing device operating independently, or may include two or more computing device operating in concert, in parallel, sequentially or the like; two or more computing devices may be included together in a single computing device or in two or more computing devices. Controller 504 with one or more additional devices as described below in further detail via a network interface device. Network interface device may be utilized for connecting a controller 504 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device.

Controller 504 may include but is not limited to, for example, a controller 604 or cluster of computing devices in a first location and a second computing device or cluster of computing devices in a second location. In an embodiment, controller 504 may include one or more computing devices dedicated to data storage, security, distribution of traffic for load balancing, and the like. In an embodiment, controller 504 may distribute one or more computing tasks as described below across a plurality of computing devices of computing device, which may operate in parallel, in series, redundantly, or in any other manner used for distribution of tasks or memory between computing devices. Controller 504 may be implemented using a “shared nothing” architecture in which data is cached at the worker, in an embodiment, this may enable scalability of system 100 and/or computing device.

With continued reference to FIG. 5, stator 104, including motor inner magnet carrier 124 and motor outer magnet carrier 128, may include or be connected to one or more sensors (not shown) detecting one or more conditions of a motor. The conditions may include, without limitation, voltage levels, electromotive force, current levels, temperature, current speed of rotation, and the like. Sensors, as described herein, are any device, module, and/or subsystems, utilizing any hardware, software, and/or any combination thereof to detect events and/or changes in the instant environment and communicate the information to the controller 604. For example and without limitation, a sensor may be located inside the electric aircraft; a sensor may be inside a component of the aircraft. Sensor 116 may be incorporated into vehicle or aircraft or be remote. As a further example and without limitation, sensor may be communicatively connected to the controller 504.

Sensor 116 may communicate a current status of a motor to a person operating electric propulsion assembly 100 or a computing device. Computing device may include any computing device as described below in reference to FIG. 11, including without limitation a vehicle controller as set forth in further detail below. Persons skilled in the art, upon reviewing the entirety of this disclosure, will be aware of various devices and/or components that may be used as or included in a motor or a circuit operating a motor, as used and described herein.

Continuing to refer to FIG. 5, power source 500 may supply electrical power to a portion of stator 104. Electrical power, in the form of electric current, may generate a first magnetic field by first magnet element 108 and a second magnetic field by a second magnetic element 120 by use of inverter 208. A magnetic force between the first magnetic field and the second magnetic field may cause the rotor assembly of electric propulsion assembly 100 to rotate with respect to the stationary components of the motor assembly. Electric propulsion assembly 100 may include an electric motor. Electric motor may be a DC brushless motor.

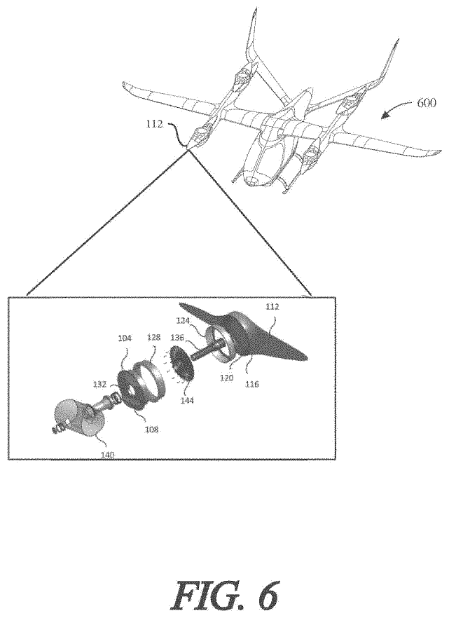

Now referring to FIG. 6, integrated electric propulsor assembly 100 may be mounted on a structural feature. Design of integrated electric propulsion assembly 100 may enable it to be installed external to the structural member (such as a boom, nacelle, or fuselage) for easy maintenance access and to minimize accessibility requirements for the structure. This may improve structural efficiency by requiring fewer large holes in the mounting area. This design may include two main holes in the top and bottom of the mounting area to access bearing cartridge 140. Further, a structural feature may include a component of an aircraft 600. For example and without limitation structural feature may be any portion of a vehicle incorporating integrated electric propulsion assembly 100, including any vehicle as described below. As a further non-limiting example, a structural feature may include without limitation a wing, a spar, an outrigger, a fuselage, or any portion thereof; persons skilled in the art, upon reviewing the entirety of this disclosure, will be aware of many possible features that may function as at least a structural feature. At least a structural feature may be constructed of any suitable material or combination of materials, including without limitation metal such as aluminum, titanium, steel, or the like, polymer materials or composites, fiberglass, carbon fiber, wood, or any other suitable material. As a non-limiting example, at least a structural feature may be constructed from additively manufactured polymer material with a carbon fiber exterior; aluminum parts or other elements may be enclosed for structural strength, or for purposes of supporting, for instance, vibration, torque or shear stresses imposed by at least a propulsor 112. Persons skilled in the art, upon reviewing the entirety of this disclosure, will be aware of various materials, combinations of materials, and/or constructions techniques.

Still referring to FIG. 6, electric aircraft 600 may include a vertical takeoff and landing aircraft (eVTOL). As used herein, a vertical take-off and landing (eVTOL) aircraft is one that can hover, take off, and land vertically. An eVTOL, as used herein, is an electrically powered aircraft typically using an energy source, of a plurality of energy sources to power the aircraft. In order to optimize the power and energy necessary to propel the aircraft. eVTOL may be capable of rotor-based cruising flight, rotor-based takeoff, rotor-based landing, fixed-wing cruising flight, airplane-style takeoff, airplane-style landing, and/or any combination thereof. Rotor-based flight, as described herein, is where the aircraft generated lift and propulsion by way of one or more powered rotors coupled with an engine, such as a “quad copter,” multi-rotor helicopter, or other vehicle that maintains its lift primarily using downward thrusting propulsors. Fixed-wing flight, as described herein, is where the aircraft is capable of flight using wings and/or foils that generate life caused by the aircraft's forward airspeed and the shape of the wings and/or foils, such as airplane-style flight.

With continued reference to FIG. 6, a number of aerodynamic forces may act upon the electric aircraft 600 during flight. Forces acting on an electric aircraft 600 during flight may include, without limitation, thrust, the forward force produced by the rotating element of the electric aircraft 600 and acts parallel to the longitudinal axis. Another force acting upon electric aircraft 600 may be, without limitation, drag, which may be defined as a rearward retarding force which is caused by disruption of airflow by any protruding surface of the electric aircraft 600 such as, without limitation, the wing, rotor, and fuselage. Drag may oppose thrust and acts rearward parallel to the relative wind. A further force acting upon electric aircraft 600 may include, without limitation, weight, which may include a combined load of the electric aircraft 600 itself, crew, baggage, and/or fuel. Weight may pull electric aircraft 600 downward due to the force of gravity. An additional force acting on electric aircraft 600 may include, without limitation, lift, which may act to oppose the downward force of weight and may be produced by the dynamic effect of air acting on the airfoil and/or downward thrust from the propulsor 112 of the electric aircraft. Lift generated by the airfoil may depend on speed of airflow, density of air, total area of an airfoil and/or segment thereof, and/or an angle of attack between air and the airfoil. For example and without limitation, electric aircraft 600 are designed to be as lightweight as possible. Reducing the weight of the aircraft and designing to reduce the number of components is essential to optimize the weight. In order to save energy, it may be useful to reduce weight of components of an electric aircraft 600, including without limitation propulsors and/or propulsion assemblies. In an embodiment, integrated electric propulsion assembly 100 may eliminate need for many external structural features that otherwise might be needed to join one component to another component. Integrated electric propulsion assembly 100 may also increase energy efficiency by enabling a lower physical propulsor profile, reducing drag and/or wind resistance. This may also increase durability by lessening the extent to which drag and/or wind resistance add to forces acting on electric aircraft 600 and/or propulsors.

Still referring to FIG. 6, electric aircraft 600 can include at least an integrated electric propulsion assembly 100. Electric propulsion assembly 100 includes a stator 104 which has a first magnetic generating element generating a first magnetic field. Electric propulsion assembly 100 also includes a propulsor 112 with an integrated rotor assembly of the motor assembly which includes a hub 116 mounted to stator 104, at least a second magnetic element generating a second magnetic field. First magnetic field and second magnetic field vary with respect to time which generates a magnetic force between both causing the rotor assembly to rotate with respect to stator 104.

An embodiment of a stator, such as without limitation stator 104 as described above may include varying windings. Varying windings such as angularly varying windings, such as a varying winding consisting of an angled orientation to the stator, nonhomogeneous varying windings, such as varying windings consisting of differing attributes wherein the attributes may include, size, shape, location, placement, and the like, and/or any combination thereof, for instance and without limitation as described above. A stator may further include varying windings, wherein the varying windings may have a varying number of turns per section of a stator as a function of the location of the varying winding on the annular stator, for instance and without limitation as described above. A stator may include a stator shaped in an annular arrangement, wherein the annular arrangement includes windings that vary annularly around a stator, for instance and without limitation as described above. As a further example and without limitation, a stator may be configured to generate a varying magnetic field that varies with respect to time, wherein the varying magnetic field comprises a difference between a first orientation of a first magnetic field and a second orientation of a second magnetic field, as described above in reference to FIGS. 1-5. The varying magnetic field may further include generating a magnetic force between the at least a first magnetic element 108, for instance as described above, and at least a second magnetic element, for instance as described above, magnetic force may cause a hub, such as without limitation a hub 116 as described above, to rotate with respect to stator, for instance and without limitation as described above in reference to FIGS. 1-5. As another non-limiting example, a stator may interact with a rotor; the rotor may be is integrated in a propulsor, for instance and without limitation as described above in reference to FIGS. 1-5. As a further example and without limitation, a stator may interact with an alternator, as described above in further detail. The alternator, as described herein, is an electrical generator that converts mechanical energy to electrical energy in the form of alternating current. For another example, a stator may interact and/or be included in any part and/or combination of parts of a motor; wherein the motor may include any motor as described above in reference to FIGS. 1-5.

In an embodiment, the above-described elements may alleviate problems resulting from systems where weight and space of the design cause an extra demand on power source 500 of an electric aircraft. When designing a propulsion unit for an aircraft, a profile of the propulsion unit may be minimized to reduce profile drag. Reducing profile drag will reduce the demand on the power source 500 which will allow for extended flight maneuvers such as hovering. Using a hub 116 integrated with the rotating elements of integrated electric propulsion assembly 100 including rotor assembly, propulsor 112 and hub 116, may allow for ease of maintenance, installation and removal. As one integrated unit, the rotating components of integrated electric propulsion 100 form a rigid unit that can be easily separated from the stationary pieces, such as stator 104. As one unit, integrated electric propulsion assembly may be installed and removed as one piece. This may reduce maintenance time and wear and tear of the components internal to assembly 100. Reducing weight of the system also may result in a more efficient use of the power source 500 and allows for additional operational time if necessary. The reduction of weight is a result of removing components of the design of integrated electric propulsion assembly 100. Integrated cooling apparatus 300 may be designed with air ducts and channels to direct air flow from external to the aircraft and distribute that air throughout the assembly to cool components which may experience heat during use. Cooling apparatus 300 removes the needs for a cooling media and accompanying system which reduces the weight of the system.

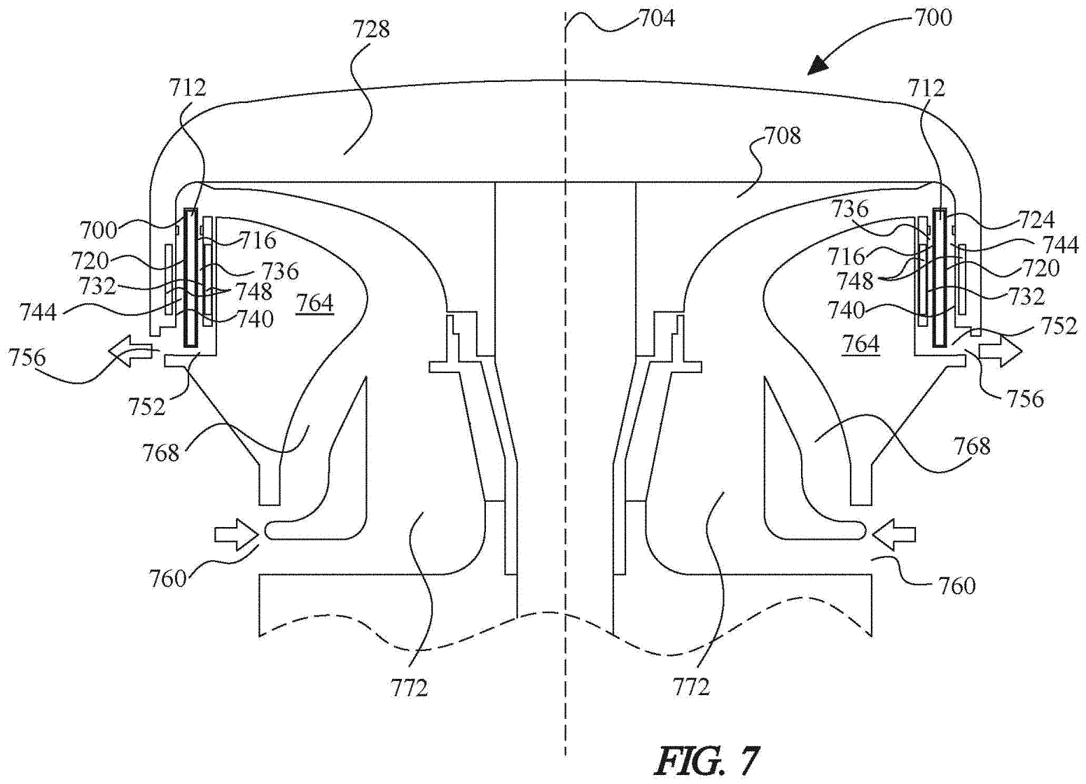

Referring now to FIG. 7, a cross-sectional view of an exemplary embodiment of an electrical propulsor motor 700 with an axial cooling system is illustrated. Motor 700 includes an axis of rotation 704 about which a rotor 728 of motor may rotate, for instance as described above in reference to FIGS. 1-6.

Still referring to FIG. 7, motor 700 includes a stator 708. Stator 708 may be affixed to an vertical take-off and landing aircraft, for instance as described above in reference to FIGS. 1-6. Stator 708 may include any components and/or elements as disclosed above in reference to FIGS. 1-6. Stator 708 includes a hollow cylinder 712 about the axis of rotation 704. Hollow cylinder 712 includes an inner cylindrical surface 716 facing toward axis of rotation 704 and an outer cylindrical surface 720 facing away from the axis of rotation 704. Elements of stator 708 and/or hollow cylinder 712 may be implemented according to any embodiment described in this disclosure, including without limitation as described above in reference to FIGS. 1-6. Stator 708 may include a plurality of windings 724 located between the inner cylindrical surface 716 and the outer cylindrical surface 720. Plurality of windings 724 may be implemented and/or may function as a first magnetic element as described above; for instance, plurality of windings 724 may interact with one or more magnetic fields generated by at least a second magnetic element attached to a rotor 728 as described above, to urge the rotor 728 to rotate about rotational axis.

With continued reference to FIG. 7, motor 700 includes a rotor 728. Rotor 728 may include any component and/or may be implemented in any way described above in reference to FIGS. 1-6; for instance and without limitation, rotor 728 may be incorporated in a hub of a propulsor as described above. Rotor 728 is mounted to stator 708; mounting may be performed, without limitation, as described above in reference to FIGS. 1-6. Rotor 728 is mounted rotatably about axis of rotation 704; this may be accomplished, without limitation, as described above in reference to FIGS. 1-6. Rotor 728 may include at least a second magnetic element as described above, which may interact with a field generated by a first magnetic element of stator 708, such as without limitation a plurality of windings 724 located between the inner cylindrical surface 716 and the outer cylindrical surface 720. Rotor 728 includes a first cylindrical surface 732 facing inner cylindrical surface 716; that is, a portion of rotor 728 is a member coaxially inserted within hollow cylinder 712 and between inner surface and axis of rotation 704, and that coaxially inserted member has a first cylindrical surface 732 facing away from axis of rotation 704 and having a lesser radius than inner cylindrical surface 716, such that the coaxially inserted member is free to rotate about the axis of rotation 704 within hollow cylinder 712. Coaxially inserted member bearing first cylindrical surface 732 may in turn have a form of a cylindrical shell or may be a partially or wholly solid cylinder. Inner cylindrical surface 716 and first cylindrical surface 732 combine to form a first air gap 736.

Still referring to FIG. 7, rotor 728 includes a second cylindrical surface 740 facing the outer cylindrical surface 720; that is, a portion of rotor 728 is a member coaxially placed around hollow cylinder 712 such that outer surface is between the coaxially placed member and that coaxially inserted member has a second cylindrical surface 740 facing toward axis of rotation 704 and having a greater radius than outer cylindrical surface 720, such that the member coaxially placed around hollow cylinder 712 is free to rotate about the axis of rotation 704 around hollow cylinder 712. Member coaxially placed around hollow cylinder 712 and bearing second cylindrical surface 740 may in turn have a form of a cylindrical shell or may have any other form that contains a cylindrical space within it having second cylindrical surface 740. Outer cylindrical surface 720 and second cylindrical surface 740 combine to form a second air gap 744.

Continuing to refer to FIG. 7, rotor 728 may include at least a second magnetic element as described above; for instance, and without limitation, rotor 728 may include a first plurality of magnets 748 located axially inward from first cylindrical surface 732. First plurality of magnets 748 may, for instance, be a part of, be attached to, and/or be imbedded in a coaxially inserted member bearing first surface. Rotor 728 may include a second plurality of magnets 748 located axially outward from second cylindrical surface 740; for instance, second plurality of magnets 748 may be a part of, be attached to, and/or be imbedded in a coaxially placed member bearing second surface. Rotor 728 may include and/or be attached to a bearing shaft 730 rotatably attaching the rotor 728 to the stator 708; this may be implemented, without limitation, as described above in reference to FIGS. 1-6.

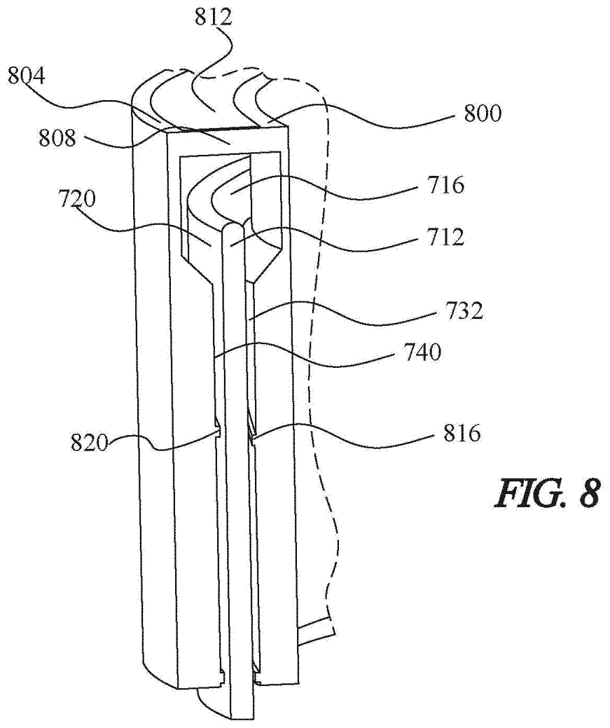

Referring now to FIG. 8, a partially sectioned view of a detail of an exemplary embodiment of motor 700 is illustrated. In an embodiment, first cylindrical surface 732 has an upper edge 800, second cylindrical surface 740 has an upper edge 804, and rotor 728 includes a connecting structure 808 attaching the upper edge 800 of the first cylindrical surface 732 to the upper edge 804 of the second cylindrical surface 740. Connecting structure 808 may include a set of struts, bars, or other rigid elements connecting a coaxially inserted member to a member coaxially inserted around hollow cylinder 712 as described above; either member may alternatively or additionally be attached to additionally portions of rotor 728 and/or propulsor. In an embodiment, connecting structure 808 at least a through-opening 812 connected to first air gap 736 and second air gap 744; at least a through-opening may permit passage of air into and/or out of first air gap 736 and second air gap 744, for instance into and/or out of one or more additional passages as described in further detail below.

Still referring to FIG. 8, motor 700 includes a plurality of axial impeller vanes mounted to at least one of first cylindrical surface 732 and the second cylindrical surface 740 and within at least one of the first air gap 736 and the second air gap 744. Each vane of the plurality of axial impeller vanes is positioned to force air through the at least one of the first air gap 736 and the second air gap 744 when the rotor 728 rotates about the axis of rotation 704; for instance, each vane may have a curved and/or angled surface that pushes against air and forces the air downward or upward in any chosen axial direction, which axial direction may be chosen based on a structural arrangement of assembly as described above, upon rotation. Plurality of axial impeller vanes may include a first plurality of axial impeller vanes 816 mounted to the first cylindrical surface 732 and a second plurality of axial impeller vanes 820 mounted to the second cylindrical surface 740. Material composition of vanes may include a dielectric material such as without limitation polycarbonate, polymethyl methacrylate, acrylonitrile butadiene styrene (ABS), or the like; material may be rigid enough to sustain aero loads and compliant enough to be affixed to the rotor. Material may be formed on the rotor itself or may be formed separately and then affixed to the rotor, for instance as described below.

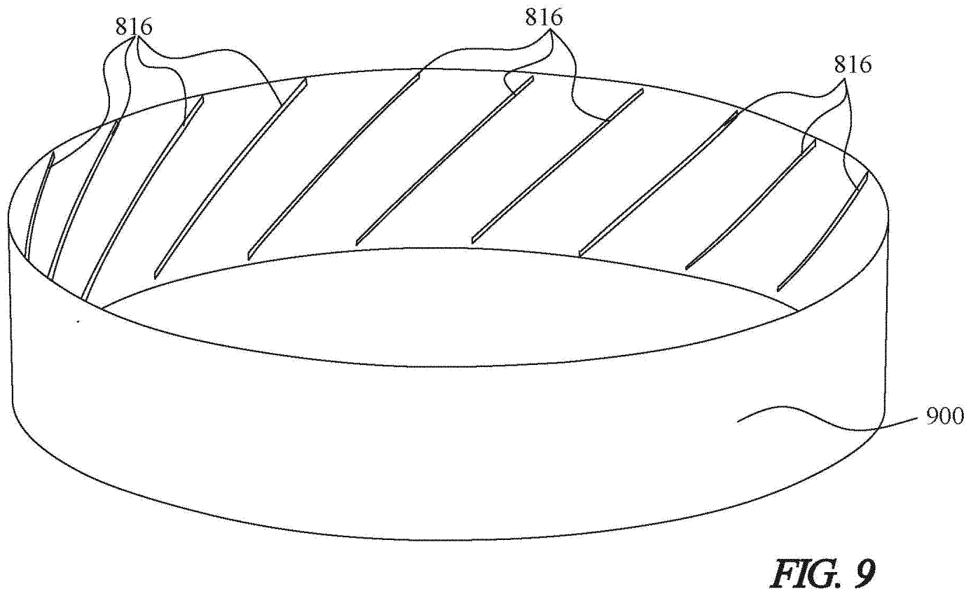

Referring now to FIG. 9, first plurality of axial impeller vanes 816 may be attached to a first liner 900. First liner 900 may be constructed of any material suitable for construction of axial impeller vanes; first liner 900 may be manufactured together with first plurality of axial impeller vanes 816, for instance in an additive manufacturing process and/or molding process, and/or first plurality of axial impeller vanes 816 may be manufactured separately and adhered, fused using heat, and/or otherwise attached to first liner 900. First liner 900 may be adhered to first cylindrical surface 740 to attach first plurality of axial impeller vanes 816 to first cylindrical surface 740 using any suitable process for attachment of first plurality of axial impeller vanes 816 to first liner 900; alternatively or additionally, where motor 700 does not include first liner 900, first plurality of axial impeller vanes 816 may be directly adhered to first cylindrical surface 732 using any process suitable for attachment of first plurality of axial impeller vanes 816 to first liner 900, and/or formed with first cylindrical surface 732. Each vane of first plurality of axial impeller vanes 816 may be angled and/or helical in form, where “helical” indicates a curvature that describes a portion of a helix centered around axis of rotation 704, for instance describing a section of a helix running across first cylindrical surface 732.

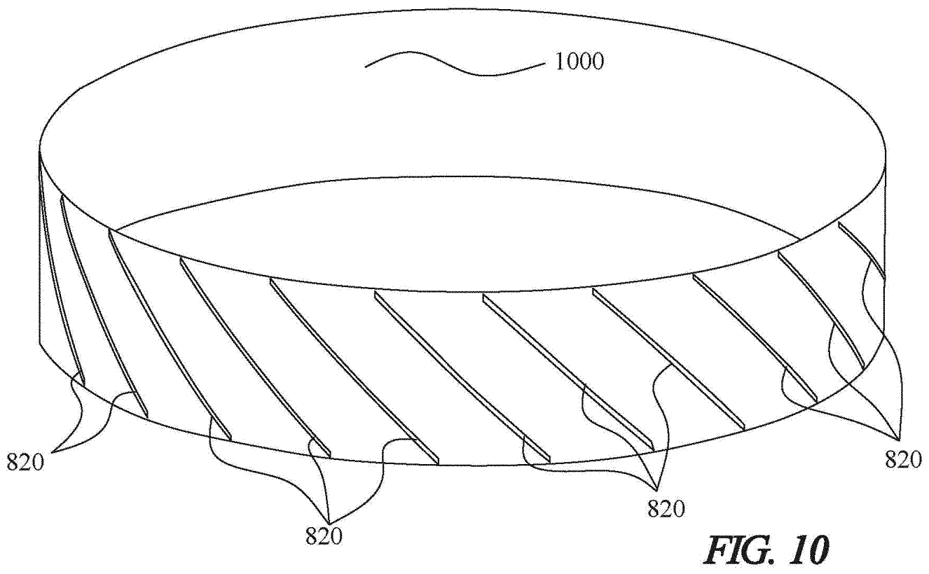

Referring now to FIG. 10, second plurality of axial impeller vanes 820 may be attached to a second liner 1000. Second liner 1000 may be constructed of any material suitable for construction of axial impeller vanes; second liner 1000 may be manufactured together with second plurality of axial impeller vanes 820, for instance in an additive manufacturing process and/or molding process, and/or second plurality of axial impeller vanes 820 may be manufactured separately and adhered, fused using heat, and/or otherwise attached to second liner 1000.

Attachment may be accomplished in any manner suitable for attachment of first plurality of axial impeller vanes 816 to first liner 900, as described above. Second liner 1000 may be adhered to second cylindrical surface 740 to attach second plurality of axial impeller vanes 820 to second cylindrical surface 740, using any suitable process for attachment of second plurality of axial impeller vanes 820 to second liner 1000; alternatively or additionally, where motor 700 does not include second liner 1000, second plurality of axial impeller vanes 820 may be directly adhered to second cylindrical surface 740 using any process suitable for attachment of second plurality of axial impeller vanes 820 to second liner 1000, and/or may be formed with second cylindrical surface 740. Each vane of second plurality of axial impeller vanes 820 may be angled and/or helical in form, where “helical” indicates a curvature that describes a portion of a helix centered around axis of rotation 704, for instance describing a section of a helix running across second cylindrical surface 740.

Referring again to FIG. 7, motor 700 may include one or more passages permitting intake and/or exhaust of air into and/or from motor 700, first air gap 736, and/or second air gap 744. For instance, and without limitation, motor may include a first air passage 752 connecting first air gap 736 and second air gap 744 to air exterior to the motor. First passage may include a passage connecting lower ends of first air gap 736 and/or second air gap 744 to air exterior to motor 700. In an embodiment, first passage may include and/or connect to an exhaust opening 756 from which air heated by components of motor 700 is expelled. Air may be drawn in through at least an intake opening 760 from outside motor 700; where motor is mounted to an aircraft as described above, at least an intake opening 760 may admit air from outside aircraft. One or more components of motor 700 may be cooled by air received via at least an intake opening 760. For instance, motor 700 may include at least an inverter 764 electrically connected to stator 708. Motor 700 may include a second air passage 768 from at least one of the first air gap 736 and the second air gap 744 to the at least an inverter 764; second air passage 768 may connect to at least an intake opening 760, permitting movement of air by means of axial impeller vanes to draw air from at least an intake opening 760 via second air passage 768 and past at least an inverter 764, cooling at least an inverter 764. As a further non-limiting example, motor 700 may include a stator 708 interior and a third air passage 772 from the at least one of the first air gap 736 and the second air gap 744 into the stator 708 interior; third air passage 772 may connect to at least an intake opening 760, permitting movement of air by means of axial impeller vanes to draw air from at least an intake opening 760 via third air passage 772 and through stator 708 interior, cooling stator 708 interior. Second and third air passage 772s may be configured to draw different volumes of air; for instance, where stator 708 requires more cooling than at least an inverter 764, second air passage 768 may have a second air passage 768 cross-sectional area, third air passage 772 may have a third air passage 772 cross-sectional area, and the second air passage 768 cross-sectional area may be smaller than the third air passage 772 cross-sectional area. Where inverter requires more cooling, third air passage 772 cross-sectional area may be greater than second air passage 768 cross-sectional area. Motor 700 may include additional air passages to, past, and/or through one or more additional components of motor 700 and/or of an aircraft including motor.

Still referring to FIG. 7, cooling using axial impeller vanes and passages may be used alone to cool motor 700 and/or other components, and/or may be combined with one or more additional cooling devices and/or systems, including without limitation any cooling device and/or system described above in reference to FIGS. 1-6.

Referring now to the FIG. 11, an exemplary embodiment of a dual-motor propulsion assembly 1100 of an electric aircraft 1104 in accordance with one or more embodiments of the present disclosure is illustrated. Dual-motor propulsion assembly 1100 may include embodiments as disclosed in Nonprovisional application Ser. No. 17/702,069 (Attorney Docket No. 1024-288USC1), filed on Mar. 23, 2022, and entitled “A DUAL-MOTOR PROPULSION ASSEMBLY,” which is incorporated by reference herein in its entirety. Dual-motor propulsion assembly 1100 may include embodiments as disclosed in Nonprovisional application Ser. No. 18/143,862 (Attorney Docket No. 1024-288USC1), filed on May 5, 2023, and entitled “A DUAL-MOTOR PROPULSION ASSEMBLY,” which is incorporated by reference herein in its entirety. In one or more embodiments of the present disclosure, dual-motor propulsion assembly 1100 may include a flight component, such as propulsor 1108. As used in this disclosure, a “flight component” is a portion of an electric aircraft that can be used to maneuver and/or move an electric aircraft through a fluid medium, such as a propulsor 1108. Propulsor 1108 may include any device or component that consumes electrical power on demand to propel an electric aircraft in a direction while on ground or in-flight. As described above. For example, and without limitation, propulsor may include a rotor, propeller, paddle wheel, and the like thereof. In an embodiment, propulsor may include a plurality of blades that radially extend from a hub of the propulsor so that the blades may convert a rotary motion from a motor into a swirling slipstream. In an embodiment, blade may convert rotary motion to push an aircraft forward or backward. For instance, and without limitation, propulsor 1108 may include an assembly including a rotating power-driven hub, to which several radially-extending airfoil-section blades are fixedly attached thereto, where the whole assembly rotates about a central longitudinal axis A. The blade pitch of a propeller may, for example, be fixed, manually variable to a few set positions, automatically variable (e.g., a “constant-speed” type), or any combination thereof. In an exemplary embodiment, propellers for an aircraft may be designed to be fixed to their hub at an angle similar to the thread on a screw makes an angle to the shaft; this angle may be referred to as a pitch or pitch angle which will determine the speed of the forward movement as the blade rotates. In one or more exemplary embodiments, propulsor 1108 may include a vertical propulsor or a forward propulsor. A forward propulsor may include a propulsor configured to propel aircraft 1104 in a forward direction. A vertical propulsor may include a propulsor configured to propel aircraft 1104 in an upward direction. One of ordinary skill in the art would understand upward to comprise the imaginary axis protruding from the earth at a normal angle, configured to be normal to any tangent plane to a point on a sphere (i.e. skyward). In an embodiment, vertical propulsor can be a propulsor that generates a substantially downward thrust, tending to propel an aircraft in an opposite, vertical direction and provides thrust for maneuvers. Such maneuvers can include, without limitation, vertical take-off, vertical landing, hovering, and/or rotor-based flight such as “quadcopter” or similar styles of flight.

In one or more embodiments, propulsor 1108 can include a thrust element which may be integrated into the propulsor. The thrust element may include, without limitation, a device using moving or rotating foils, such as one or more rotors, an airscrew, or propeller, a set of airscrews or propellers such as contra-rotating propellers, a moving or flapping wing, or the like. Further, a thrust element, for example, can include without limitation a marine propeller or screw, an impeller, a turbine, a pump-jet, a paddle or paddle-based device, or the like. In one or more embodiments, propulsor 1108 may include a pusher component. As used in this disclosure a “pusher component” is a component that pushes and/or thrusts an aircraft through a medium. As a non-limiting example, pusher component may include a pusher propeller, a paddle wheel, a pusher motor, a pusher propulsor, and the like. Pusher component may be configured to produce a forward thrust. As used in this disclosure a “forward thrust” is a thrust that forces aircraft through a medium in a horizontal direction, wherein a horizontal direction is a direction parallel to the longitudinal axis. For example, forward thrust may include a force of 1145 N to force electric aircraft 1104 in a horizontal direction along a longitudinal axis of electric aircraft 1104. As a further non-limiting example, pusher component may twist and/or rotate to pull air behind it and, at the same time, push electric aircraft 1104 forward with an equal amount of force. In an embodiment, and without limitation, the more air forced behind aircraft, the greater the thrust force with which electric aircraft 1104 is pushed horizontally will be. In another embodiment, and without limitation, forward thrust may force electric aircraft 1104 through the medium of relative air. Additionally or alternatively, plurality of propulsor may include one or more puller components. As used in this disclosure a “puller component” is a component that pulls and/or tows an aircraft through a medium. As a non-limiting example, puller component may include a flight component such as a puller propeller, a puller motor, a tractor propeller, a puller propulsor, and the like. Additionally, or alternatively, puller component may include a plurality of puller flight components.

In one or more embodiments, dual-motor propulsion assembly 1100 may include a plurality of motors, which includes a first motor 1112 and a second motor 1116 (also referred to herein in the singular as “motor” or plural as “motors”). Each motor 1112,1116 is mechanically connected to a flight component, such as propulsor 1108, of electric aircraft 1104. Motors 1112,1116 are each configured to convert an electrical energy and/or signal into a mechanical movement of a flight component, such as, for example, by rotating a shaft attached to propulsor 1108 that subsequently rotates propulsor 1108 about a longitudinal axis A of shaft. In one or more embodiments, motors 1112,1116 may be driven by direct current (DC) electric power. For instance, and without limitation, a motor may include a brushed DC motor or the like. In one or more embodiments, motors 1112,1116 may be a brushless DC electric motor, a permanent magnet synchronous motor, a switched reluctance motor, and/or an induction motor. In other embodiments, motors 1112,1116 may be driven by electric power having varying or reversing voltage levels, such as alternating current (AC) power as produced by an alternating current generator and/or inverter, or otherwise varying power, such as produced by a switching power source. Persons skilled in the art, upon reviewing the entirety of this disclosure, will be aware of various alternative or additional forms and/or configurations that a motor may take or exemplify as consistent with this disclosure. In addition to inverter and/or switching power source, a circuit driving motor may include electronic speed controllers (not shown) or other components for regulating motor speed, rotation direction, torque, and/or dynamic braking.

With continued reference to FIG. 11, the first motor 1112 and the second motor 1116 may include an encoderless motor. An encoderless motor is a type of motor that operates without a position sensor, such as an encoder or resolver. Instead, it uses an algorithm to estimate the rotor position based on the measured current and/or voltage signals. Encoderless motors may be used in applications where the use of position sensors is not practical or cost-effective, such as in high-speed motors or harsh environments. The estimation algorithm used in encoderless motors typically involves a mathematical model of the motor, which takes into account the electrical, mechanical, and magnetic properties of the motor. The algorithm uses the measured voltage and current signals to calculate the position and velocity of the rotor, based on the known model parameters. The algorithm may involve a combination of motor physics and control theory, and it can be implemented using different approaches, depending on the specific motor and application requirements. One approach to the algorithm used in encoderless motors is the observer-based approach, which is based on the idea of using an observer to estimate the unmeasured states of the motor, such as the rotor position and velocity. The observer is a mathematical model that takes the measured inputs (voltage and current) and outputs (motor speed and torque) and estimates the unmeasured states based on the known motor dynamics. The observer-based approach typically involves two main steps: the state estimation and the feedback control. In the state estimation step, the observer uses the measured inputs and outputs to estimate the rotor position and velocity. The observer model includes a set of equations that describe the motor dynamics and relate the estimated states to the measured inputs and outputs. In the feedback control step, the estimated states are used to generate control signals that are applied to the motor in order to achieve the desired performance. The control algorithm can be a standard control technique, such as proportional-integral-derivative (PID) control, or a more advanced control method, such as model predictive control (MPC) or adaptive control. The accuracy of the encoderless motor algorithm may depend on several factors, such as the quality of the voltage and current measurements, the accuracy of the motor model, and the stability of the control algorithm. In some cases, the algorithm may need to be calibrated or fine-tuned in order to achieve the desired performance. However, with proper design and implementation, encoderless motors can provide accurate and reliable operation, even in harsh or noisy environments.

In one or more embodiments, each motor 1112,1116 may include a rotor coaxial disposed within a stator. As understood a rotor is a portion of an electric motor that rotates with respect to a stator, which remains stationary relative to a corresponding electric aircraft. In one or more embodiments, assembly 1100 includes a shaft that extends through each motor 1112,1116. Motors 1112,1116 may be arranged such that one motor may be stacked atop the other motor. For example, and without limitation, first motor 1112 and second motor 1116 may share an axis, such as, for example, motors 1112,1116 may be coaxially positioned along longitudinal axis A of shaft 1120 while first motor 1112 may be positioned closer to a flight component than second motor 1116 along longitudinal axis A. In one or more embodiments, assembly 1100 may include a clutch. For example, and without limitation, each motor 1112,1116 may include a clutch 1124,1128, respectively, that engages or disengages shaft 1120 upon receipt of an command from a controller, as discussed further in this disclosure. Each clutch 1124,1128 may include an electro-mechanical clutch. In one or more embodiments, clutches 1124, 1128 are configured to engage or disengage a power transmission to each motor 1112,1116, respectively. In one or more embodiments, a clutch may include a sprag clutch, electromagnetic clutch, a sacrificial weak component to break at a threshold torque, one-time breakaway clutch, such as a sheering element that would break free at a designated torque, and/or any other clutch component.

Still in referring to FIG. 11, each clutch 1124,1128 may include a freewheel clutch. As used in the current disclosure, a “freewheel clutch” is a clutch that selectively disengages or engages one or more of the plurality of motors from the driveshaft. In an embodiment, the a freewheel clutch may consist of a plurality saw-toothed, spring-loaded discs pressing against each other with the toothed sides together, somewhat like a ratchet. Rotating in one direction, the saw teeth of the drive disc may lock with the teeth of the driven disc, making it rotate at the same speed. If the drive disc slows down or stops rotating, the teeth of the driven disc slip over the drive disc teeth and continue rotating. In other embodiments A more sophisticated and rugged design has spring-loaded steel rollers inside a driven cylinder. Rotating in one direction, the rollers lock with the cylinder making it rotate in unison. Rotating slower, or in the opposite direction, the steel rollers just slip inside the cylinder. In other embodiments, in rotorcraft such as aircraft 1100, a rotorcraft's blades may need to spin faster than its drive engines. For example, it may be especially important in the event of an engine failure where a freewheel in the main transmission lets each motor 1112,1116 continue to spin independent of the drive system. This may provide for continued flight control and an autorotation landing. A freewheel clutch may include a sprag clutch. As used in the current disclosure, a “sprag clutch” is a freewheel clutch that allows the clutch to spin in only one direction. The operation of a sprag clutch may be based on the principle of wedging action. When the input member rotates in the forward direction, the sprags may be forced to roll along the inclined surface of the outer race, which wedges them against the inner race and causes the clutch to transmit torque. However, when the input member tries to rotate in the opposite direction, the sprags may be forced to roll backwards along the inclined surface, which disengages them from the inner race and allows the output or driven member to rotate freely. A sprag clutch employs, non-revolving asymmetric figure-eight shaped sprags, or other elements allowing single direction rotation, are used. For example. when the unit rotates in one direction the rollers slip or free-wheel, but when a torque is applied in the opposite direction, the sprags tilt slightly, producing a wedging action and binding because of friction.

Still referring to FIG. 11, assembly 1100 includes a sensor configured to detect a motor characteristic of motors 1112,1116. In one or more embodiments, a sensor may include a first sensor 1132 communicatively connected to first motor 1112, and a second sensor 1136 communicatively connected to second motor 1116. As used in this disclosure, a “sensor” is a device that is configured to detect an event and/or a phenomenon and transmit information and/or datum related to the detection. For instance, and without limitation, a sensor may transform an electrical and/or physical stimulation into an electrical signal that is suitable to be processed by an electrical circuit, such as controller 1140. A sensor may generate a sensor output signal, which transmits information and/or datum related to a detection by the sensor. A sensor output signal may include any signal form described in this disclosure, for example digital, analog, optical, electrical, fluidic, and the like. In some cases, a sensor, a circuit, and/or a controller may perform one or more signal processing steps on a signal. For instance, a sensor, circuit, and/or controller may analyze, modify, and/or synthesize a signal in order to improve the signal, for instance by improving transmission, storage efficiency, or signal to noise ratio.

In one or more embodiments, each motor 1112,1116 may include or be connected to one or more sensors detecting one or more conditions and/or characteristics of motors 1112,1116. One or more conditions may include, without limitation, voltage levels, electromotive force, current levels, temperature, current speed of rotation, position sensors, torque, and the like. For instance, and without limitation, one or more sensors may be used to detect torque, or to detect parameters used to determine torque, as described in further detail below. One or more sensors may include a plurality of current sensors, voltage sensors, speed or position feedback sensors, such as encoders, and the like. A sensor may communicate a current status of motor to a person operating system or a computing device; computing device may include any computing device as described below, including without limitation, a controller, a processor, a microprocessor, a control circuit, a flight controller, or the like. In one or more embodiments, computing device may use sensor feedback to calculate performance parameters of motor, including without limitation a torque versus speed operation envelope. Persons skilled in the art, upon reviewing the entirety of this disclosure, will be aware of various devices and/or components that may be used as or included in a motor or a circuit operating a motor, as used and described herein.

In one or more embodiments, each sensor 1132,1136 may detect a motor characteristic, such as position, displacement, and/or speed, of a component of each motor 1112,1116, respectively. For the purposes of this disclosure, a “motor characteristic” is a physical or electrical phenomenon associated with an operation and/or condition of a motor. In one or more embodiments, a sensor of assembly 1100 may generate a failure datum as a function of a motor characteristic and transmit the failure datum to a controller. For example, and without limitation, each sensor 1132,1136 may transmit an output signal that, for example, includes failure datum to a controller, as discussed further in this disclosure. For the purposes of this disclosure, “failure datum” is an electrical signal representing information related to a motor characteristic of a motor and/or components thereof. Failure datum may include any condition that reduces the predetermined output of the motors. Failure datum may include data regarding a motor that is temporarily or permanently experiencing a reduced output capacity. A failure datum may include an identification of the reduced capacity of a motor without deeming the motor as inoperable. In a non-limiting example, failure datum may include information regarding the reduced torque output of a first motor 1112 or a second motor 1116. In some embodiments, one motor may be commanded to produce more torque when the other motor is experiencing a malfunction as indicated by the failure datum. In an embodiment, a failure datum may include data related to a motor malfunction or failure, such as in an inoperable motor. As used in the current disclosure, an “inoperable motor” is a motor that is experiencing a severe malfunction. This malfunction include the complete inoperability of the motor for any amount of time. An inoperable motor may include a motor that cannot be operated or is not functional. This can be due to a variety of reasons such as mechanical or electrical failures, lack of maintenance, or damage to the motor. An inoperable motor can also refer to a motor that is incapable of performing its intended function due to limitations or design flaws. In any case, an inoperable motor is unable to function as it was designed to and may require repair or replacement to restore it to proper working condition.

In one or more embodiments, each sensor 1132,1136 may include a plurality of sensors in the form of individual sensors or a sensor suite working in tandem or individually. A sensor suite may include a sensor array having a plurality of independent sensors, where any number of the described sensors may be used to detect any number of physical or electrical quantities associated with an electric vehicle. For example, sensor suite may include a plurality of sensors where each sensor detects the same physical phenomenon. Independent sensors may include separate sensors measuring physical or electrical quantities that may be powered by and/or in communication with circuits independently, where each may signal sensor output to a control circuit such as a user graphical interface. In a non-limiting example, there may be a plurality of sensors housed in and/or on electric vehicle and/or components thereof, such as battery pack of electric aircraft, measuring temperature, electrical characteristic such as voltage, amperage, resistance, or impedance, or any other parameters and/or quantities as described in this disclosure. In one or more embodiments, use of a plurality of independent sensors may also result in redundancy configured to employ more than one sensor that measures the same phenomenon, those sensors being of the same type, a combination of, or another type of sensor not disclosed, to detect a specific characteristic and/or phenomenon.

[In one or more embodiments, each sensor 1132,1136 may include an electrical sensor. An electrical sensor may be configured to measure a voltage across a component, electrical current through a component, and resistance of a component. In one or more non-limiting embodiments, an electrical sensor may include a voltmeter, ammeter, ohmmeter, and the like. For example, and without limitation, an electrical sensor may measure power from a power source of an electric aircraft being provided to a motor.

In one or more embodiments, each sensor 1132,1136 may include a temperature sensor. In one or more embodiments, a temperature sensor may include thermocouples, thermistors, thermometers, infrared sensors, resistance temperature sensors (RTDs), semiconductor based integrated circuits (IC), and the like. “Temperature”, for the purposes of this disclosure, and as would be appreciated by someone of ordinary skill in the art, is a measure of the heat energy of a system. Temperature, as measured by any number or combinations of sensors present, may be measured in Fahrenheit (° F.), Celsius (° C.), Kelvin (° K), or another scale alone, or in combination.

Still referring to FIG. 11, each sensor 1132,1136 may include a motion sensor. A motion sensor refers to a device or component configured to detect physical movement of an object or grouping of objects. One of ordinary skill in the art would appreciate, after reviewing the entirety of this disclosure, that motion may include a plurality of types including but not limited to: spinning, rotating, oscillating, gyrating, jumping, sliding, reciprocating, or the like. A motion sensor may include, torque sensor, gyroscope, accelerometer, position, sensor, magnetometer, inertial measurement unit (IMU), pressure sensor, force sensor, proximity sensor, displacement sensor, vibration sensor, or the like. In one or more embodiments, each sensor 1132,1136 may include various other types of sensors configured to detect a physical phenomenon of each motor 1112,1116, respectively. For instance, each sensor 1132,1136 may include photoelectric sensors, radiation sensors, infrared sensors, and the like. Each sensor 1132,1136 may include contact sensors, non-contact sensors, or a combination thereof. In one or more embodiments, each sensor 1132,1136 may include digital sensors, analog sensors, or a combination thereof. Each sensor 1132,1136 may include digital-to-analog converters (DAC), analog-to-digital converters (ADC, A/D, A-to-D), a combination thereof, or other signal conditioning components used in transmission of measurement data to a destination, such as controller 1140, over a wireless and/or wired connection.

In one or more embodiments, each sensor 1132,1136 may include an encoder. In one or more embodiments, first motor 1112 may include a first encoder 1144, and second motor 1116 may include a second encoder 1148. In one or more embodiments, each encoder 1144,1148 may be configured to detect a rotation angle of a motor, where the encoder converts an angular position and/or motion of a shaft of each motor 1112,1116, respectively, to an analog and/or digital output signal. In some cases, for example, each encoder 1144,1148 may include a rotational encoder and/or rotary encoder that is configured to sense a rotational position of a pilot control, such as a throttle level, and/or motor component; in this case, the rotational encoder digitally may sense rotational “clicks” by any known method, such as without limitation magnetically, optically, and the like. In one or more embodiments, encoders 1144,1148 may include a mechanical encoder, optical encoder, on-axis magnetic encoder, and/or an off-axis magnetic encoder. In one or more embodiments, an encoder includes an absolute encoder or an incremental encoder. For example, and without limitation, encoders 1144,1148 may include an absolute encoder, which continues to monitor position information related to corresponding motors 1112,1116 even when encoders 1144,1148 are no longer receiving power from, for example, a power source of electric aircraft 1104. Once power is returned to encoders 1144,1148, encoders 1144,1148 may provide the detected position information to a controller. In another example, and without limitation, encoder 1144,1148 may include an incremental encoder, where changes in position of motor are monitored and immediately reported by the encoders 1144,1148. In one or more embodiments, encoders 1144,1148 may include a closed feedback loop or an open feedback loop. In one or more exemplary embodiments, an encoder is configured to determine a motion of a motor, such as a speed in revolutions per minute of the motor. An encoder may be configured to transmit an output signal, which includes feedback, to a controller and/or motor; as a result, the motor may operate based on the received feedback from the encoder. For example, and without limitation, a clutch of a motor may engage a shaft of assembly 1100 if the motor is determined to be operational based on feedback from a corresponding encoder. However, if a motor is determined to be inoperative based on feedback from a corresponding encoder, then a clutch of the motor may be disengaged form the shaft so that the other motor may engage the shaft and provide motive power to the flight component attached to the shaft.

Still referring to FIG. 11, dual-motor propulsion assembly 1100 may include a controller 1140. In one or more embodiments, controller 1140 is communicatively connected to the plurality of motors. In one or more embodiments, controller 1140 is communicatively connected to each motor 1112,1116. In one or more embodiments, controller 1140 may be communicatively connected to a sensor. For instance, and without limitation, controller 1140 may be communicatively connected to each sensor 1132,1136. In other embodiments, controller 1140 may be communicatively connected to each clutch 1124,1128. For the purposes of this disclosure, “communicatively connected” is a process whereby one device, component, or circuit is able to receive data from and/or transmit data to another device, component, or circuit. A communicative connection may be performed by wired or wireless electronic communication; either directly or by way of one or more intervening devices or components. In an embodiment, a communicative connection includes electrically connecting an output of one device, component, or circuit to an input of another device, component, or circuit. Communicative connection may be performed via a bus or other facility for intercommunication between elements of a computing device. Communicative connection may include indirect connections via “wireless” connection, low power wide area network, radio communication, optical communication, magnetic, capacitive, or optical coupling, or the like. In one or more embodiments, a communicative connection may be wireless and/or wired. For example, controller 1140 may communicative with sensors 1132,1136 and/or clutches via a controller area network (CAN) communication.

In one or more embodiments, controller 1140 may include a flight controller, computing device, a central processing unit (CPU), a microprocessor, a digital signal processor (DSP), an application specific integrated circuit (ASIC), a control circuit, a combination thereof, or the like. In one or more embodiments, output signals, such as motor datum, from sensors 1132,1136 and/or controller 1140 may be analog or digital. Controller 1140 may convert output signals from a sensor to a usable form by the destination of those signals. The usable form of output signals from sensors 1132,1136 and through controller 1140 may be either digital, analog, a combination thereof, or an otherwise unstated form. Processing by controller 1140 may be configured to trim, offset, or otherwise compensate the outputs of sensors. Based on output of the sensors, controller 1140 may determine the output to send to a downstream component. Controller 1140 may perform signal amplification, operational amplifier (Op-Amp), filter, digital/analog conversion, linearization circuit, current-voltage change circuits, resistance change circuits such as Wheatstone Bridge, an error compensator circuit, a combination thereof or otherwise undisclosed components.

In one or more embodiments, controller 1140 may include a timer that works in conjunction to determine regular intervals. In other embodiments, controller 1140 may continuously update datum provided by sensors 1132,1136. Furthermore, data from sensors 1132,1136 may be continuously stored on a memory component of controller 1140. A timer may include a timing circuit, internal clock, or other circuit, component, or part configured to keep track of elapsed time and/or time of day. For example, in non-limiting embodiments, a memory component may save a critical event datum and/or condition datum from sensors 1132,1136, such as failure datum, every 30 seconds, every minute, every 30 minutes, or another time period according to a timer.

Controller 1140 may be designed and/or configured to perform any method, method step, or sequence of method steps in any embodiment described in this disclosure, in any order and with any degree of repetition. For instance, controller 1140 may be configured to perform a single step or sequence repeatedly until a desired or commanded outcome is achieved. Repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Controller 1140 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing. Controller 1140, as well as any other components or combination of components, may be connected to a controller area network (CAN), which may interconnect all components for signal transmission and reception.

In one or more embodiments, controller 1140 may receive a transmitted output signal, such as failure datum, from sensors 1132,1136. For example, and without limitation, first sensor 1132 may detect that first motor 1112 has received a pilot command from a pilot via a pilot control of electric aircraft 1104, such as a throttle actuation indicating a desired motor speed increase. First sensor 1132 may then detect a motor characteristic of first motor 1112. Subsequently, first encoder 1144 may transmit failure datum to controller 1140 if first sensor 1132 detects that motor is inoperative, such as for example, if first motor 1112 does not move in response to the pilot command. As a result, controller 1140 may alert, for example, a pilot of the inoperativeness and transmit a signal to second motor to move the flight component. For example, second motor may engage shaft 1120 and rotate shaft 1120 about longitudinal axis A to provide motive power to propulsor 1108 so that propulsor moves as intended by the pilot command of the pilot. Therefore, second motor 1116 provides redundancy such that, if first motor 1112 fails, propulsor 1108 may remain operational as second motor 1116 continues to move propulsor 1108. System redundancies performed by controller 1140 and/or motors 1112,1116 may include any systems for redundant flight control as described in U.S. Nonprovisional application Ser. No. 17/404,614, filed on Aug. 17, 2021, and entitled “SYSTEMS AND METHODS FOR REDUNDANT FLIGHT CONTROL IN AN AIRCRAFT,” the entirety of which is incorporated herein by reference.

With continued reference to FIG. 1, controller 1140 may be configured maintain a set of flight parameters throughout the flight. As used in the current disclosure, a “flight parameter” is one or more measurements or variables that are used to describe the flight characteristics of an aircraft. Flight parameters may include altitude, velocity, airspeed, heading, pitch, roll, vertical speed, acceleration, Mach number, fuel quantity, batter status, battery efficiency, battery temperature, and the like. Flight parameters may be detected using sensors such as altitude sensors, inertial measurement units (IMUs), temperature sensors, battery sensors, GPS tracking, and the like. Controller 1140 may compare the detected flight parameters to the desired flight parameters to determine any necessary motor adjustments. Controller 1140 may automatically maintain one or more flight parameters by adjusting the position or the output of the plurality of motors. Should a motor experience a reduced output for whatever reason, controller 1140 may command the other motors to compensate automatically. This may be done without the need for a failure determination. The compensation may comprise an adjustment of the torque output of one or both motors. The compensation may also comprise an adjustment of the position of one or both motors. In an embodiment, one motor may be commanded to produce more torque when the other fails, even without a determination of an inoperable motor. In an non-limiting example, if sensors 1132,1136 provide an indication to controller 1140 that the aircraft is losing altitude because the reduced capacity of a first motor 1112. Controller 1140 may compensate for the lost output of the first motor 1112 using the second motor 1116. This may be done by increasing the torque output of the second motor 1116 to compensate for the lost torque output of the first motor 1116. A controller 1140 may make these adjustments automatically without deeming the first motor 1112 as inoperable.

Continuing to reference FIG. 11, system 1100 may include a plurality of inverters. Inverter is configured to convert a direct current (DC) from an energy source to an alternating current. An “inverter,” as used in this this disclosure, is an electronic device or circuitry that changes direct current (DC) to alternating current (AC). A plurality of inverters may include a first inverter and a second inverter. An inverter (also called a power inverter) may be entirely electronic or may include at least a mechanism (such as a rotary apparatus) and electronic circuitry. In some embodiments, static inverters may not use moving parts in conversion process. Inverters may not produce any power itself; rather, inverters may convert power produced by a DC power source. Inverters may often be used in electrical power applications where high currents and voltages are present; circuits that perform a similar function, as inverters, for electronic signals, having relatively low currents and potentials, may be referred to as oscillators. In some cases, circuits that perform opposite function to an inverter, converting AC to DC, may be referred to as rectifiers. Inverter may be configured to accept direct current and produce alternating current. As used in this disclosure, “alternating current” is a flow of electric charge that periodically reverses direction. In some cases, an alternating current may continuously change magnitude overtime; this is in contrast to what may be called a pulsed direct current. As used herein, “direct current” is a flow of electric charge in only one direction. Alternatively or additionally, in some cases an alternating current may not continuously vary with time, but instead exhibit a less smooth temporal form. For example, exemplary non-limiting AC waveforms may include a square wave, a triangular wave (i.e., sawtooth), a modifier sine wave, a pulsed sine wave, a pulse width modulated wave, and/or a sine wave. Specifically, first inverter and/or second inverter may supply AC power to drive a first electric motor 1112 and/or a second electric motor 1116. First inverter and/or second inverter may be entirely electronic or a combination of mechanical elements and electronic circuitry. First inverter and/or second inverter may allow for variable speed and torque of the motor based on the demands of the vehicle. An inverter may be used to connect the motors to a flight controller. In a non-limiting example, a first/second inverter may be electrically connected to the first/second motor respectively. The first/second motor may be communicatively connected to the flight controller by way of the first/second inverter. An In some embodiments, first inverter and/or second inverter may be used a controller for first electric motor 1112 and/or second electric motor 1116. In some embodiments, first inverter may be configured to control first electric motor 1112. In some embodiments, second inverter may be configured to control second electric motor 1116. In some embodiments, first and/or second inverter may control first electric motor and/or second electric motor as a function of signals from controller 1140 and/or a flight controller.inverter may be communicatively connected to both the motors 1112/1116 and the flight controller.

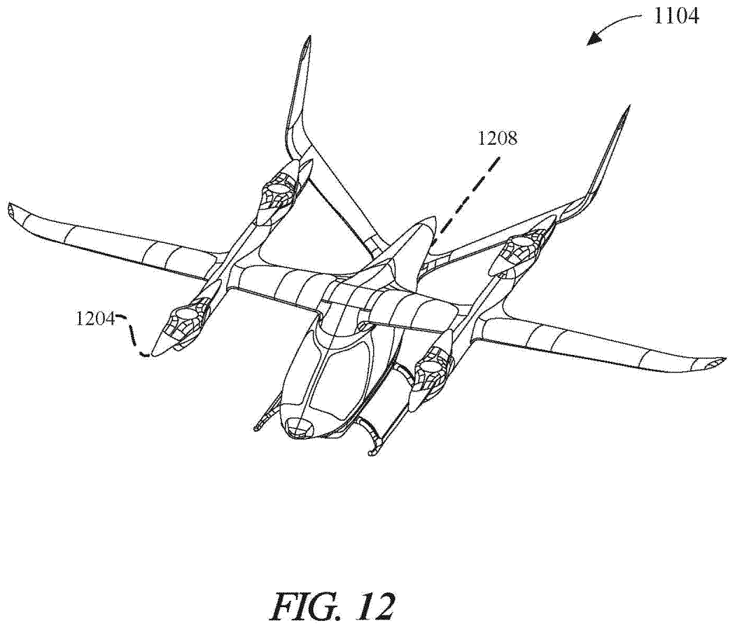

Referring now to FIG. 12, an exemplary embodiment of an electric aircraft 1104 is illustrated. As used in this disclosure an “aircraft” is any vehicle that may fly by gaining support from the air. As a non-limiting example, aircraft may include airplanes, helicopters, commercial and/or recreational aircrafts, instrument flight aircrafts, drones, electric aircrafts, airliners, rotorcrafts, vertical takeoff and landing aircrafts, jets, airships, blimps, gliders, paramotors, and the like. Aircraft 1104 may include an electrically powered aircraft. In embodiments, electrically powered aircraft may be an electric vertical takeoff and landing (eVTOL) aircraft. Electric aircraft may be capable of rotor-based cruising flight, rotor-based takeoff, rotor-based landing, fixed-wing cruising flight, airplane-style takeoff, airplane-style landing, and/or any combination thereof. Electric aircraft may include one or more manned and/or unmanned aircrafts. Electric aircraft may include one or more all-electric short takeoff and landing (eSTOL) aircrafts. For example, and without limitation, eVTOL aircrafts may accelerate plane to a flight speed on takeoff and decelerate plane after landing. In an embodiment, and without limitation, electric aircraft may be configured with an electric propulsion assembly. Electric propulsion assembly may include any electric propulsion assembly as described in U.S. Nonprovisional application Ser. No. 16/603,225, filed on Dec. 4, 2019, and entitled “AN INTEGRATED ELECTRIC PROPULSION ASSEMBLY,” the entirety of which is incorporated herein by reference.

As used in this disclosure, a vertical take-off and landing (eVTOL) aircraft is an aircraft that can hover, take off, and land vertically. An eVTOL, as used in this disclosure, is an electrically powered aircraft typically using an energy source, of a plurality of energy sources to power aircraft. To optimize the power and energy necessary to propel aircraft 1100, eVTOL may be capable of rotor-based cruising flight, rotor-based takeoff, rotor-based landing, fixed-wing cruising flight, airplane-style takeoff, airplane style landing, and/or any combination thereof. Rotor-based flight, as described herein, is where the aircraft generates lift and propulsion by way of one or more powered rotors or blades coupled with an engine, such as a “quad-copter,” multi-rotor helicopter, or other vehicle that maintains its lift primarily using downward thrusting propulsors. “Fixed-wing flight”, as described herein, is where an aircraft is capable of flight using wings and/or foils that generate lift caused by the aircraft's forward airspeed and the shape of the wings and/or foils, such as airplane-style flight.

With continued reference to FIG. 12, a number of aerodynamic forces may act upon the electric aircraft 1104 during flight. Forces acting on an electric aircraft 1104 during flight may include, without limitation, thrust, the forward force produced by the rotating element of the electric aircraft 1104 and acts parallel to the longitudinal axis. Another force acting upon electric aircraft 1104 may be, without limitation, drag, which may be defined as a rearward retarding force which is caused by disruption of airflow by any protruding surface of the electric aircraft 1104 such as, without limitation, the wing, rotor, and fuselage. Drag may oppose thrust and acts rearward parallel to the relative wind. A further force acting upon electric aircraft 1104 may include, without limitation, weight, which may include a combined load of the electric aircraft 1104 itself, crew, baggage, and/or fuel. Weight may pull electric aircraft 1104 downward due to the force of gravity. An additional force acting on electric aircraft 1104 may include, without limitation, lift, which may act to oppose the downward force of weight and may be produced by the dynamic effect of air acting on the airfoil and/or downward thrust from the propulsor of the electric aircraft. Lift generated by the airfoil may depend on speed of airflow, density of air, total area of an airfoil and/or segment thereof, and/or an angle of attack between air and the airfoil. For example, and without limitation, electric aircraft 1104 are designed to be as lightweight as possible. Reducing the weight of the aircraft and designing to reduce the number of components is essential to optimize the weight. To save energy, it may be useful to reduce weight of components of an electric aircraft 1104, including without limitation propulsors and/or propulsion assemblies. In some embodiments, electric aircraft 1104 may include at least on vertical propulsor 1204. In an embodiment, electric aircraft 1104 may include at least one forward propulsor 1208. In an embodiment, the motor may eliminate need for many external structural features that otherwise might be needed to join one component to another component. The motor may also increase energy efficiency by enabling a lower physical propulsor profile, reducing drag and/or wind resistance. This may also increase durability by lessening the extent to which drag and/or wind resistance add to forces acting on electric aircraft 1104 and/or propulsors.

In one or more embodiments, a motor of electric aircraft 1104, which may be mounted on a structural feature of an aircraft. Design of motors 1112,1116 may enable them to be installed external to the structural member (such as a boom, nacelle, or fuselage) for easy maintenance access and to minimize accessibility requirements for the structure. This may improve structural efficiency by requiring fewer large holes in the mounting area. This design may include two main holes in the top and bottom of the mounting area to access bearing cartridge. Further, a structural feature may include a component of aircraft 1104. As a further non-limiting example, a structural feature may include without limitation a wing, a spar, an outrigger, a fuselage, or any portion thereof; persons skilled in the art, upon reviewing the entirety of this disclosure, will be aware of many possible features that may function as at least a structural feature. At least a structural feature may be constructed of any suitable material or combination of materials, including without limitation metal such as aluminum, titanium, steel, or the like, polymer materials or composites, fiberglass, carbon fiber, wood, or any other suitable material. As a non-limiting example, at least a structural feature may be constructed from additively manufactured polymer material with a carbon fiber exterior; aluminum parts or other elements may be enclosed for structural strength, or for purposes of supporting, for instance, vibration, torque or shear stresses imposed by at least propulsor 1104. Persons skilled in the art, upon reviewing the entirety of this disclosure, will be aware of various materials, combinations of materials, and/or constructions techniques.

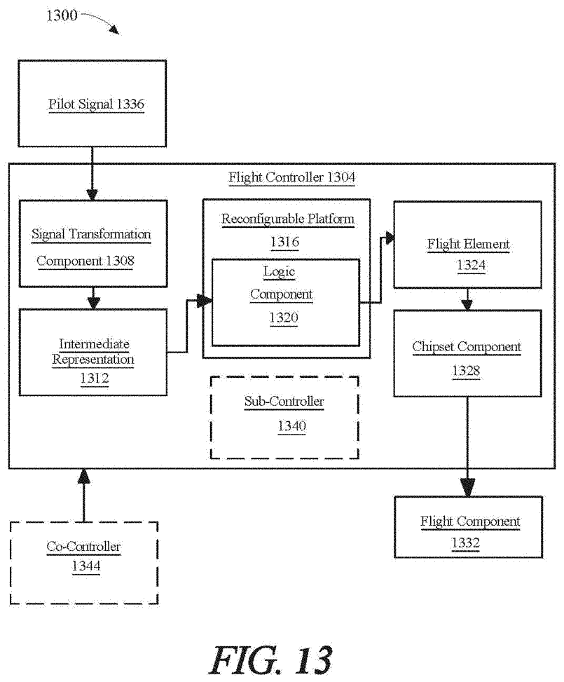

Now referring to FIG. 13, an exemplary embodiment 1300 of a flight controller 1304 is illustrated. As used in this disclosure a “flight controller” is a computing device of a plurality of computing devices dedicated to data storage, security, distribution of traffic for load balancing, and flight instruction. Flight controller 1304 may include and/or communicate with any computing device as described in this disclosure, including without limitation a microcontroller, microprocessor, digital signal processor (DSP) and/or system on a chip (SoC) as described in this disclosure. Further, flight controller 1304 may include a single computing device operating independently, or may include two or more computing device operating in concert, in parallel, sequentially or the like; two or more computing devices may be included together in a single computing device or in two or more computing devices. In embodiments, flight controller 1304 may be installed in an aircraft, may control the aircraft remotely, and/or may include an element installed in the aircraft and a remote element in communication therewith.

In an embodiment, and still referring to FIG. 13, flight controller 1304 may include a signal transformation component 1308. As used in this disclosure a “signal transformation component” is a component that transforms and/or converts a first signal to a second signal, wherein a signal may include one or more digital and/or analog signals. For example, and without limitation, signal transformation component 1308 may be configured to perform one or more operations such as preprocessing, lexical analysis, parsing, semantic analysis, and the like thereof. In an embodiment, and without limitation, signal transformation component 1308 may include one or more analog-to-digital convertors that transform a first signal of an analog signal to a second signal of a digital signal. For example, and without limitation, an analog-to-digital converter may convert an analog input signal to a 10-bit binary digital representation of that signal. In another embodiment, signal transformation component 1308 may include transforming one or more low-level languages such as, but not limited to, machine languages and/or assembly languages. For example, and without limitation, signal transformation component 1308 may include transforming a binary language signal to an assembly language signal. In an embodiment, and without limitation, signal transformation component 1308 may include transforming one or more high-level languages and/or formal languages such as but not limited to alphabets, strings, and/or languages. For example, and without limitation, high-level languages may include one or more system languages, scripting languages, domain-specific languages, visual languages, esoteric languages, and the like thereof. As a further non-limiting example, high-level languages may include one or more algebraic formula languages, business data languages, string and list languages, object-oriented languages, and the like thereof.

Still referring to FIG. 13, signal transformation component 1308 may be configured to optimize an intermediate representation 1312. As used in this disclosure an “intermediate representation” is a data structure and/or code that represents the input signal. Signal transformation component 1308 may optimize intermediate representation as a function of a data-flow analysis, dependence analysis, alias analysis, pointer analysis, escape analysis, and the like thereof. In an embodiment, and without limitation, signal transformation component 1308 may optimize intermediate representation 1312 as a function of one or more inline expansions, dead code eliminations, constant propagation, loop transformations, and/or automatic parallelization functions. In another embodiment, signal transformation component 1308 may optimize intermediate representation as a function of a machine dependent optimization such as a peephole optimization, wherein a peephole optimization may rewrite short sequences of code into more efficient sequences of code. Signal transformation component 1308 may optimize intermediate representation to generate an output language, wherein an “output language,” as used herein, is the native machine language of flight controller 1304. For example, and without limitation, native machine language may include one or more binary and/or numerical languages.

In an embodiment, and without limitation, signal transformation component 1308 may include transform one or more inputs and outputs as a function of an error correction code. An error correction code, also known as error correcting code (ECC), is an encoding of a message or lot of data using redundant information, permitting recovery of corrupted data. An ECC may include a block code, in which information is encoded on fixed-size packets and/or blocks of data elements such as symbols of predetermined size, bits, or the like. Reed-Solomon coding, in which message symbols within a symbol set having q symbols are encoded as coefficients of a polynomial of degree less than or equal to a natural number k, over a finite field F with q elements; strings so encoded have a minimum hamming distance of k+1, and permit correction of (q−k−1)/2 erroneous symbols. Block code may alternatively or additionally be implemented using Golay coding, also known as binary Golay coding, Bose-Chaudhuri, Hocquenghuem (BCH) coding, multidimensional parity-check coding, and/or Hamming codes. An ECC may alternatively or additionally be based on a convolutional code.

In an embodiment, and still referring to FIG. 13, flight controller 1304 may include a reconfigurable hardware platform 1316. A “reconfigurable hardware platform,” as used herein, is a component and/or unit of hardware that may be reprogrammed, such that, for instance, a data path between elements such as logic gates or other digital circuit elements may be modified to change an algorithm, state, logical sequence, or the like of the component and/or unit. This may be accomplished with such flexible high-speed computing fabrics as field-programmable gate arrays (FPGAs), which may include a grid of interconnected logic gates, connections between which may be severed and/or restored to program in modified logic. Reconfigurable hardware platform 1316 may be reconfigured to enact any algorithm and/or algorithm selection process received from another computing device and/or created using machine-learning processes.

Still referring to FIG. 13, reconfigurable hardware platform 1316 may include a logic component 1320. As used in this disclosure a “logic component” is a component that executes instructions on output language. For example, and without limitation, logic component may perform basic arithmetic, logic, controlling, input/output operations, and the like thereof. Logic component 1320 may include any suitable processor, such as without limitation a component incorporating logical circuitry for performing arithmetic and logical operations, such as an arithmetic and logic unit (ALU), which may be regulated with a state machine and directed by operational inputs from memory and/or sensors; logic component 1320 may be organized according to Von Neumann and/or Harvard architecture as a non-limiting example. Logic component 1320 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC). In an embodiment, logic component 1320 may include one or more integrated circuit microprocessors, which may contain one or more central processing units, central processors, and/or main processors, on a single metal-oxide-semiconductor chip. Logic component 1320 may be configured to execute a sequence of stored instructions to be performed on the output language and/or intermediate representation 1312. Logic component 1320 may be configured to fetch and/or retrieve the instruction from a memory cache, wherein a “memory cache,” as used in this disclosure, is a stored instruction set on flight controller 1304. Logic component 1320 may be configured to decode the instruction retrieved from the memory cache to opcodes and/or operands. Logic component 1320 may be configured to execute the instruction on intermediate representation 1312 and/or output language. For example, and without limitation, logic component 1320 may be configured to execute an addition operation on intermediate representation 1312 and/or output language.

In an embodiment, and without limitation, logic component 1320 may be configured to calculate a flight element 1324. As used in this disclosure a “flight element” is an element of datum denoting a relative status of aircraft. For example, and without limitation, flight element 1324 may denote one or more torques, thrusts, airspeed velocities, forces, altitudes, groundspeed velocities, directions during flight, directions facing, forces, orientations, and the like thereof. For example, and without limitation, flight element 1324 may denote that aircraft is cruising at an altitude and/or with a sufficient magnitude of forward thrust. As a further non-limiting example, flight status may denote that is building thrust and/or groundspeed velocity in preparation for a takeoff. As a further non-limiting example, flight element 1324 may denote that aircraft is following a flight path accurately and/or sufficiently.

Still referring to FIG. 13, flight controller 1304 may include a chipset component 1328. As used in this disclosure a “chipset component” is a component that manages data flow. In an embodiment, and without limitation, chipset component 1328 may include a northbridge data flow path, wherein the northbridge dataflow path may manage data flow from logic component 1320 to a high-speed device and/or component, such as a RAM, graphics controller, and the like thereof. In another embodiment, and without limitation, chipset component 1328 may include a southbridge data flow path, wherein the southbridge dataflow path may manage data flow from logic component 1320 to lower-speed peripheral buses, such as a peripheral component interconnect (PCI), industry standard architecture (ICA), and the like thereof. In an embodiment, and without limitation, southbridge data flow path may include managing data flow between peripheral connections such as ethernet, USB, audio devices, and the like thereof. Additionally or alternatively, chipset component 1328 may manage data flow between logic component 1320, memory cache, and a flight component 1332. As used in this disclosure a “flight component” is a portion of an aircraft that can be moved or adjusted to affect one or more flight elements. For example, flight component 1332 may include a component used to affect the aircrafts' roll and pitch which may comprise one or more ailerons. As a further example, flight component 1332 may include a rudder to control yaw of an aircraft. In an embodiment, chipset component 1328 may be configured to communicate with a plurality of flight components as a function of flight element 1324. For example, and without limitation, chipset component 1328 may transmit to an aircraft rotor to reduce torque of a first lift propulsor and increase the forward thrust produced by a pusher component to perform a flight maneuver.

In an embodiment, and still referring to FIG. 13, flight controller 1304 may be configured generate an autonomous function. As used in this disclosure an “autonomous function” is a mode and/or function of flight controller 1304 that controls aircraft automatically. For example, and without limitation, autonomous function be part of an autopilot mode where an autonomous function may perform one or more aircraft maneuvers, take offs, landings, altitude adjustments, flight leveling adjustments, turns, climbs, and/or descents. As a further non-limiting example, autonomous function may adjust one or more airspeed velocities, thrusts, torques, and/or groundspeed velocities. As a further non-limiting example, autonomous function may perform one or more flight path corrections and/or flight path modifications as a function of flight element 1324. In an embodiment, autonomous function may include one or more modes of autonomy such as, but not limited to, autonomous mode, semi-autonomous mode, and/or non-autonomous mode. As used in this disclosure “autonomous mode” is a mode that automatically adjusts and/or controls aircraft and/or the maneuvers of aircraft in its entirety. For example, autonomous mode may denote that flight controller 1304 will adjust the aircraft. As used in this disclosure a “semi-autonomous mode” is a mode that automatically adjusts and/or controls a portion and/or section of aircraft. For example, and without limitation, semi-autonomous mode may denote that a pilot will control the propulsors, wherein flight controller 1304 will control the ailerons and/or rudders. As used in this disclosure “non-autonomous mode” is a mode that denotes a pilot will control aircraft and/or maneuvers of aircraft in its entirety.

In an embodiment, and still referring to FIG. 13, flight controller 1304 may generate autonomous function as a function of an autonomous machine-learning model. As used in this disclosure an “autonomous machine-learning model” is a machine-learning model to produce an autonomous function output given flight element 1324 and a pilot signal 1336 as inputs; this is in contrast to a non-machine learning software program where the commands to be executed are determined in advance by a user and written in a programming language. As used in this disclosure a “pilot signal” is an element of datum representing one or more functions a pilot is controlling and/or adjusting. For example, pilot signal 1336 may denote that a pilot is controlling and/or maneuvering ailerons, wherein the pilot is not in control of the rudders and/or propulsors. In an embodiment, pilot signal 1336 may include an implicit signal and/or an explicit signal. For example, and without limitation, pilot signal 1336 may include an explicit signal, wherein the pilot explicitly states there is a lack of control and/or desire for autonomous function. As a further non-limiting example, pilot signal 1336 may include an explicit signal directing flight controller 1304 to control and/or maintain a portion of aircraft, a portion of the flight plan, the entire aircraft, and/or the entire flight plan. As a further non-limiting example, pilot signal 1336 may include an implicit signal, wherein flight controller 1304 detects a lack of control such as by a malfunction, torque alteration, flight path deviation, and the like thereof. In an embodiment, and without limitation, pilot signal 1336 may include one or more explicit signals to reduce torque, and/or one or more implicit signals that torque may be reduced due to reduction of airspeed velocity. In an embodiment, and without limitation, pilot signal 1336 may include one or more local and/or global signals. For example, and without limitation, pilot signal 1336 may include a local signal that is transmitted by a pilot and/or crew member. As a further non-limiting example, pilot signal 1336 may include a global signal that is transmitted by air traffic control and/or one or more remote users that are in communication with the pilot of aircraft. In an embodiment, pilot signal 1336 may be received as a function of a tri-state bus and/or multiplexor that denotes an explicit pilot signal should be transmitted prior to any implicit or global pilot signal.

Still referring to FIG. 13, autonomous machine-learning model may include one or more autonomous machine-learning processes such as supervised, unsupervised, or reinforcement machine-learning processes that flight controller 1304 and/or a remote device may or may not use in the generation of autonomous function. As used in this disclosure “remote device” is an external device to flight controller 1304. Additionally or alternatively, autonomous machine-learning model may include one or more autonomous machine-learning processes that a field-programmable gate array (FPGA) may or may not use in the generation of autonomous function. Autonomous machine-learning process may include, without limitation machine learning processes such as simple linear regression, multiple linear regression, polynomial regression, support vector regression, ridge regression, lasso regression, elasticnet regression, decision tree regression, random forest regression, logistic regression, logistic classification, K-nearest neighbors, support vector machines, kernel support vector machines, naïve bayes, decision tree classification, random forest classification, K-means clustering, hierarchical clustering, dimensionality reduction, principal component analysis, linear discriminant analysis, kernel principal component analysis, Q-learning, State Action Reward State Action (SARSA), Deep-Q network, Markov decision processes, Deep Deterministic Policy Gradient (DDPG), or the like thereof.

In an embodiment, and still referring to FIG. 13, autonomous machine-learning model may be trained as a function of autonomous training data, wherein autonomous training data may correlate a flight element, pilot signal, and/or simulation data to an autonomous function. For example, and without limitation, a flight element of an airspeed velocity, a pilot signal of limited and/or no control of propulsors, and a simulation data of required airspeed velocity to reach the destination may result in an autonomous function that includes a semi-autonomous mode to increase thrust of the propulsors. Autonomous training data may be received as a function of user-entered valuations of flight elements, pilot signals, simulation data, and/or autonomous functions. Flight controller 1304 may receive autonomous training data by receiving correlations of flight element, pilot signal, and/or simulation data to an autonomous function that were previously received and/or determined during a previous iteration of generation of autonomous function. Autonomous training data may be received by one or more remote devices and/or FPGAs that at least correlate a flight element, pilot signal, and/or simulation data to an autonomous function. Autonomous training data may be received in the form of one or more user-entered correlations of a flight element, pilot signal, and/or simulation data to an autonomous function.

Still referring to FIG. 13, flight controller 1304 may receive autonomous machine-learning model from a remote device and/or FPGA that utilizes one or more autonomous machine learning processes, wherein a remote device and an FPGA is described above in detail. For example, and without limitation, a remote device may include a computing device, external device, processor, FPGA, microprocessor, and the like thereof. Remote device and/or FPGA may perform the autonomous machine-learning process using autonomous training data to generate autonomous function and transmit the output to flight controller 1304. Remote device and/or FPGA may transmit a signal, bit, datum, or parameter to flight controller 1304 that at least relates to autonomous function. Additionally or alternatively, the remote device and/or FPGA may provide an updated machine-learning model. For example, and without limitation, an updated machine-learning model may be comprised of a firmware update, a software update, an autonomous machine-learning process correction, and the like thereof. As a non-limiting example a software update may incorporate a new simulation data that relates to a modified flight element. Additionally or alternatively, the updated machine learning model may be transmitted to the remote device and/or FPGA, wherein the remote device and/or FPGA may replace the autonomous machine-learning model with the updated machine-learning model and generate the autonomous function as a function of the flight element, pilot signal, and/or simulation data using the updated machine-learning model. The updated machine-learning model may be transmitted by the remote device and/or FPGA and received by flight controller 1304 as a software update, firmware update, or corrected autonomous machine-learning model. For example, and without limitation autonomous machine learning model may utilize a neural net machine-learning process, wherein the updated machine-learning model may incorporate a gradient boosting machine-learning process.

Still referring to FIG. 13, flight controller 1304 may include, be included in, and/or communicate with a mobile device such as a mobile telephone or smartphone. Further, flight controller may communicate with one or more additional devices as described below in further detail via a network interface device. The network interface device may be utilized for commutatively connecting a flight controller to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus, or other relatively small geographic space), a telephone network, a data network associated with a telephone/voice provider (e.g., a mobile communications provider data and/or voice network), a direct connection between two computing devices, and any combinations thereof. The network may include any network topology and can may employ a wired and/or a wireless mode of communication.

In an embodiment, and still referring to FIG. 13, flight controller 1304 may include, but is not limited to, for example, a cluster of flight controllers in a first location and a second flight controller or cluster of flight controllers in a second location. Flight controller 1304 may include one or more flight controllers dedicated to data storage, security, distribution of traffic for load balancing, and the like. Flight controller 1304 may be configured to distribute one or more computing tasks as described below across a plurality of flight controllers, which may operate in parallel, in series, redundantly, or in any other manner used for distribution of tasks or memory between computing devices. For example, and without limitation, flight controller 1304 may implement a control algorithm to distribute and/or command the plurality of flight controllers. As used in this disclosure a “control algorithm” is a finite sequence of well-defined computer implementable instructions that may determine the flight component of the plurality of flight components to be adjusted. For example, and without limitation, control algorithm may include one or more algorithms that reduce and/or prevent aviation asymmetry. As a further non-limiting example, control algorithms may include one or more models generated as a function of a software including, but not limited to Simulink by MathWorks, Natick, Mass., USA. In an embodiment, and without limitation, control algorithm may be configured to generate an auto-code, wherein an “auto-code,” is used herein, is a code and/or algorithm that is generated as a function of the one or more models and/or software's. In another embodiment, control algorithm may be configured to produce a segmented control algorithm. As used in this disclosure a “segmented control algorithm” is control algorithm that has been separated and/or parsed into discrete sections. For example, and without limitation, segmented control algorithm may parse control algorithm into two or more segments, wherein each segment of control algorithm may be performed by one or more flight controllers operating on distinct flight components.

In an embodiment, and still referring to FIG. 13, control algorithm may be configured to determine a segmentation boundary as a function of segmented control algorithm. As used in this disclosure a “segmentation boundary” is a limit and/or delineation associated with the segments of the segmented control algorithm. For example, and without limitation, segmentation boundary may denote that a segment in the control algorithm has a first starting section and/or a first ending section. As a further non-limiting example, segmentation boundary may include one or more boundaries associated with an ability of flight component 1332. In an embodiment, control algorithm may be configured to create an optimized signal communication as a function of segmentation boundary. For example, and without limitation, optimized signal communication may include identifying the discrete timing required to transmit and/or receive the one or more segmentation boundaries. In an embodiment, and without limitation, creating optimized signal communication further comprises separating a plurality of signal codes across the plurality of flight controllers. For example, and without limitation the plurality of flight controllers may include one or more formal networks, wherein formal networks transmit data along an authority chain and/or are limited to task-related communications. As a further non-limiting example, communication network may include informal networks, wherein informal networks transmit data in any direction. In an embodiment, and without limitation, the plurality of flight controllers may include a chain path, wherein a “chain path,” as used herein, is a linear communication path comprising a hierarchy that data may flow through. In an embodiment, and without limitation, the plurality of flight controllers may include an all-channel path, wherein an “all-channel path,” as used herein, is a communication path that is not restricted to a particular direction. For example, and without limitation, data may be transmitted upward, downward, laterally, and the like thereof. In an embodiment, and without limitation, the plurality of flight controllers may include one or more neural networks that assign a weighted value to a transmitted datum. For example, and without limitation, a weighted value may be assigned as a function of one or more signals denoting that a flight component is malfunctioning and/or in a failure state.

Still referring to FIG. 13, the plurality of flight controllers may include a master bus controller. As used in this disclosure a “master bus controller” is one or more devices and/or components that are connected to a bus to initiate a direct memory access transaction, wherein a bus is one or more terminals in a bus architecture. Master bus controller may communicate using synchronous and/or asynchronous bus control protocols. In an embodiment, master bus controller may include flight controller 1304. In another embodiment, master bus controller may include one or more universal asynchronous receiver-transmitters (UART). For example, and without limitation, master bus controller may include one or more bus architectures that allow a bus to initiate a direct memory access transaction from one or more buses in the bus architectures. As a further non-limiting example, master bus controller may include one or more peripheral devices and/or components to communicate with another peripheral device and/or component and/or the master bus controller. In an embodiment, master bus controller may be configured to perform bus arbitration. As used in this disclosure “bus arbitration” is method and/or scheme to prevent multiple buses from attempting to communicate with and/or connect to master bus controller. For example and without limitation, bus arbitration may include one or more schemes such as a small computer interface system, wherein a small computer interface system is a set of standards for physical connecting and transferring data between peripheral devices and master bus controller by defining commands, protocols, electrical, optical, and/or logical interfaces. In an embodiment, master bus controller may receive intermediate representation 1312 and/or output language from logic component 1320, wherein output language may include one or more analog-to-digital conversions, low bit rate transmissions, message encryptions, digital signals, binary signals, logic signals, analog signals, and the like thereof described above in detail.

Still referring to FIG. 13, master bus controller may communicate with a slave bus. As used in this disclosure a “slave bus” is one or more peripheral devices and/or components that initiate a bus transfer. For example, and without limitation, slave bus may receive one or more controls and/or asymmetric communications from master bus controller, wherein slave bus transfers data stored to master bus controller. In an embodiment, and without limitation, slave bus may include one or more internal buses, such as but not limited to a/an internal data bus, memory bus, system bus, front-side bus, and the like thereof. In another embodiment, and without limitation, slave bus may include one or more external buses such as external flight controllers, external computers, remote devices, printers, aircraft computer systems, flight control systems, and the like thereof.

In an embodiment, and still referring to FIG. 13, control algorithm may optimize signal communication as a function of determining one or more discrete timings. For example, and without limitation master bus controller may synchronize timing of the segmented control algorithm by injecting high priority timing signals on a bus of the master bus control. As used in this disclosure a “high priority timing signal” is information denoting that the information is important. For example, and without limitation, high priority timing signal may denote that a section of control algorithm is of high priority and should be analyzed and/or transmitted prior to any other sections being analyzed and/or transmitted. In an embodiment, high priority timing signal may include one or more priority packets. As used in this disclosure a “priority packet” is a formatted unit of data that is communicated between the plurality of flight controllers. For example, and without limitation, priority packet may denote that a section of control algorithm should be used and/or is of greater priority than other sections.

Still referring to FIG. 13, flight controller 1304 may also be implemented using a “shared nothing” architecture in which data is cached at the worker, in an embodiment, this may enable scalability of aircraft and/or computing device. Flight controller 1304 may include a distributer flight controller. As used in this disclosure a “distributer flight controller” is a component that adjusts and/or controls a plurality of flight components as a function of a plurality of flight controllers. For example, distributer flight controller may include a flight controller that communicates with a plurality of additional flight controllers and/or clusters of flight controllers. In an embodiment, distributed flight control may include one or more neural networks. For example, neural network also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes, one or more intermediate layers, and an output layer of nodes. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 13, a node may include, without limitation a plurality of inputs xi that may receive numerical values from inputs to a neural network containing the node and/or from other nodes. Node may perform a weighted sum of inputs using weights wi that are multiplied by respective inputs xi. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wi applied to an input xi may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wi may be determined by training a neural network using training data, which may be performed using any suitable process as described above. In an embodiment, and without limitation, a neural network may receive semantic units as inputs and output vectors representing such semantic units according to weights wi that are derived using machine-learning processes as described in this disclosure.

Still referring to FIG. 13, flight controller may include a sub-controller 1340. As used in this disclosure a “sub-controller” is a controller and/or component that is part of a distributed controller as described above; for instance, flight controller 1304 may be and/or include a distributed flight controller made up of one or more sub-controllers. For example, and without limitation, sub-controller 1340 may include any controllers and/or components thereof that are similar to distributed flight controller and/or flight controller as described above. Sub-controller 1340 may include any component of any flight controller as described above. Sub-controller 1340 may be implemented in any manner suitable for implementation of a flight controller as described above. As a further non-limiting example, sub-controller 1340 may include one or more processors, logic components and/or computing devices capable of receiving, processing, and/or transmitting data across the distributed flight controller as described above. As a further non-limiting example, sub-controller 1340 may include a controller that receives a signal from a first flight controller and/or first distributed flight controller component and transmits the signal to a plurality of additional sub-controllers and/or flight components.

Still referring to FIG. 13, flight controller may include a co-controller 1344. As used in this disclosure a “co-controller” is a controller and/or component that joins flight controller 1304 as components and/or nodes of a distributer flight controller as described above. For example, and without limitation, co-controller 1344 may include one or more controllers and/or components that are similar to flight controller 1304. As a further non-limiting example, co-controller 1344 may include any controller and/or component that joins flight controller 1304 to distributer flight controller. As a further non-limiting example, co-controller 1344 may include one or more processors, logic components and/or computing devices capable of receiving, processing, and/or transmitting data to and/or from flight controller 1304 to distributed flight control system. Co-controller 1344 may include any component of any flight controller as described above. Co-controller 1344 may be implemented in any manner suitable for implementation of a flight controller as described above.

In an embodiment, and with continued reference to FIG. 13, flight controller 1304 may be designed and/or configured to perform any method, method step, or sequence of method steps in any embodiment described in this disclosure, in any order and with any degree of repetition. For instance, flight controller 1304 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Flight controller may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

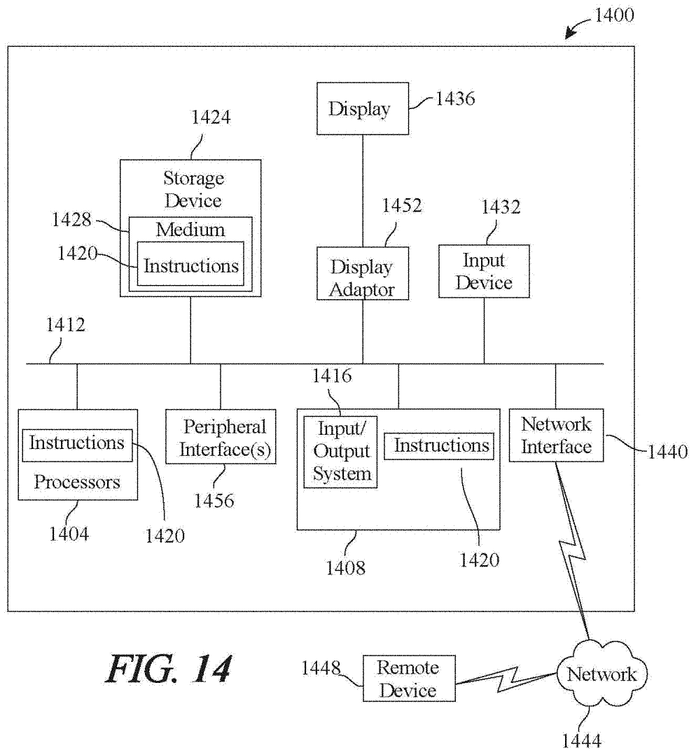

FIG. 14 shows a diagrammatic representation of one embodiment of a computing device in the exemplary form of a computer system 1400 within which a set of instructions for causing a control system, such as the integrated electric propulsion assembly 100 system of FIG. 1, to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1400 includes a processor 1404 and a memory 1408 that communicate with each other, and with other components, via a bus 1412. Bus 1412 may include any of several types of bus structures including, but not limited to, a memory bus, a memory controller, a peripheral bus, a local bus, and any combinations thereof, using any of a variety of bus architectures.

Memory 1408 may include various components (e.g., machine-readable media) including, but not limited to, a random-access memory component, a read only component, and any combinations thereof. In one example, a basic input/output system 1416 (BIOS), including basic routines that help to transfer information between elements within computer system 1400, such as during start-up, may be stored in memory 1408. Memory 1408 may also include (e.g., stored on one or more machine-readable media) instructions (e.g., software) 1420 embodying any one or more of the aspects and/or methodologies of the present disclosure. In another example, memory 1408 may further include any number of program modules including, but not limited to, an operating system, one or more application programs, other program modules, program data, and any combinations thereof.

Computer system 1400 may also include a storage device 1424. Examples of a storage device (e.g., storage device 1424) include, but are not limited to, a hard disk drive, a magnetic disk drive, an optical disc drive in combination with an optical medium, a solid-state memory device, and any combinations thereof. Storage device 1424 may be connected to bus 1412 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1424 (or one or more components thereof) may be removably interfaced with computer system 1400 (e.g., via an external port connector (not shown)). Particularly, storage device 1424 and an associated machine-readable medium 1428 may provide nonvolatile and/or volatile storage of machine-readable instructions, data structures, program modules, and/or other data for computer system 1400. In one example, software 1420 may reside, completely or partially, within machine-readable medium 1428. In another example, software 1420 may reside, completely or partially, within processor 1404.

Computer system 1400 may also include an input device 1432. In one example, a user of computer system 1400 may enter commands and/or other information into computer system 1400 via input device 1432. Examples of an input device 1432 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1432 may be interfaced to bus 1412 via any of a variety of interfaces (not shown) including, but not limited to, a serial interface, a parallel interface, a game port, a USB interface, a FIREWIRE interface, a direct interface to bus 1412, and any combinations thereof. Input device 1432 may include a touch screen interface that may be a part of or separate from display 1436, discussed further below. Input device 1432 may be utilized as a user selection device for selecting one or more graphical representations in a graphical interface as described above. A user may also input commands and/or other information to computer system 1400 via storage device 1424 (e.g., a removable disk drive, a flash drive, etc.) and/or network interface device 1440. A network interface device, such as network interface device 1440, may be utilized for connecting computer system 1400 to one or more of a variety of networks, such as network 1444, and one or more remote devices 1448 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1444, may employ a wired and/or a wireless mode of communication. In general, any network topology may be used. Information (e.g., data, software 1420, etc.) may be communicated to and/or from computer system 1400 via network interface device 1440. Computer system 1400 may further include a video display adapter 1452 for communicating a displayable image to a display device, such as display device 1436. Examples of a display device include, but are not limited to, a liquid crystal display (LCD), a cathode ray tube (CRT), a plasma display, a light emitting diode (LED) display, and any combinations thereof. Display adapter 1452 and display device 1436 may be utilized in combination with processor 1404 to provide graphical representations of aspects of the present disclosure. In addition to a display device, computer system 1400 may include one or more other peripheral output devices including, but not limited to, an audio speaker, a printer, and any combinations thereof. Such peripheral output devices may be connected to bus 1412 via a peripheral interface 1456. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. An electrical propulsor motor, the motor comprising:
an axis of rotation;
a stator affixed to a vertical take-off and landing aircraft, wherein the stator comprises a through-hole located at the axis of rotation;
a rotor mechanically coupled to a shaft and mounted in magnetic communication with the stator, wherein:
the rotor is rotatably mounted about the axis of rotation;
the rotor includes a first cylindrical surface facing the stator, wherein the stator and the first cylindrical surface form a first air gap;
a shaft operatively coupled to the rotor and rotatably mounted to the vertical take-off and landing aircraft, the shaft located coaxially with the axis of rotation;
an impeller operatively coupled to the shaft and configured to force air through an air flow path adjacent at least a winding of the stator; and
a propulsor affixed to the shaft and configured to generate a lift thrust on the electric vertical take-off and landing aircraft as a function of rotation of the shaft.

2. The motor of claim 1, wherein the stator comprises at least a first magnetic element generating a first magnetic field.

3. The motor of claim 2, wherein the at least a first magnetic element comprises a productive element.

4. The motor of claim 1, wherein the propulsor comprises at least a second magnetic element, the at least a second magnetic element generating a second magnetic field.

5. The motor of claim 4, wherein the at least a second magnetic element comprises a receptive element.

6. The motor of claim 4, wherein the rotor comprises the at least a second magnetic element.

7. The motor of claim 4, wherein the at least a second magnetic element is affixed to a hub.

8. The motor of claim 1, further comprising a varying magnetic field that varies with respect to time.

9. The motor of claim 1, further comprising a hub rotatably mounted to the stator.

10. The motor of claim 9, wherein the hub is mechanically coupled to a plurality of blades.

11. The moto of claim 9, wherein the impeller comprises a plurality of axial impeller vanes.

12. The motor of claim 1, further comprising at least an inverter electrically connected to the stator, wherein the inverter is configured to change DC power from a power source into AC power to drive the motor.

13. The motor of claim 9, wherein the hub comprises:
an interior space, wherein the impeller is located in the interior space.

14. The motor of claim 8, wherein the varying magnetic field is configured to generate a magnetic force between the at least a first magnetic element and the at least a second magnetic element wherein the magnetic force causes the rotor to rotate with respect to a stator.

15. The motor of claim 1, wherein the propulsor comprises an exterior space, wherein the exterior space further comprises a first air passage connecting the first air gap to air outside the exterior surface of the propulsor.

16. The motor of claim 1, wherein the stator is affixed to the vertical take-off and landing aircraft.

17. The motor of claim 1, wherein the stator includes a winding.

18. The motor of claim 1, wherein the stator comprises a frame.

19. The motor of claim 1, wherein the stator comprises a sensor configured to detect a temperature of the motor.

20. The motor of claim 1, further comprising a bearing cartridge, wherein the bearing cartridge is attached to a structural element of a vehicle.
